(19) United States
(12) Patent Application Publication
(10) Pub. No.: US 2008/0143691 A1
(43) Pub. Date: Jun. 19, 2008

(54) Systems and methods for enabling tablet PC/pen to paper space

(75) Inventor: John T. Cook, Louisville, CO (US)

Correspondence Address: QUITESO TECHNOLOGIES, LLC, 2410 Adams Drive, Lisle, IL, 60532, US

(73) Assignee: QuiteSo Technologies, LLC

(21) Appl. No.: 11/287,519

(22) Filed: Nov. 23, 2005

(51) Int. Cl. G06F 3/033; G06F 17/30

(52) U.S. Cl. 345/179; 707/205; 707/E17.01; 178/19.01

(57) ABSTRACT

A pen input device and a computer system are disclosed that are suitable for use with forms in a paperless environment and optionally a paper environment. The pen input device may be configured as an inertial type device so that it can be used on virtual writing surfaces and may optionally be configured to have a selectable ink mode in which the pen input device can be used as a conventional ball point pen. In accordance with an important aspect of the invention, the computer system is provided with an electronic forms library. These forms are selectable by the pen input device. The pen input device is configured to select and fill out a virtual form on a virtual writing surface with the pen input device and transmit the data to the computer system for recordation. In accordance with another aspect of the invention, the pen input device is provided with enhanced functionality relative to known pen input devices including the ability to enable peer-to-peer communication among multiple pen input devices in an ad hoc or planned network to allow collaboration among multiple pen input devices to complete the required data on a selected form. Data may also be returned to the database and then to the device for further processing and continued as needed.

### COMPUTER APPENDIX

This application includes a Computer Listing Appendix on compact disc, hereby incorporated by reference.

### BACKGROUND OF THE INVENTION

1. Field of the Invention

The present invention relates to a computer system configured to receive input signals from a multi-functional pen device that is optionally configured to be used as an electronic stylus for a tablet PC or alternatively can be used to transmit signals to a remote computer system in order to record pen down events including handwriting on virtual writing surfaces which provides enhanced functionality relative to known pen input devices including an electronic erase function and the ability to allow the pen device to be used to select and fill in—forms available from a forms library stored on the remote computer system on a virtual writing surface and transmit the completed form data to the remote computer system for recording as well as enable peer-to-peer communication among multiple pen input devices in an ad hoc or planned network to enable collaboration amongst multiple pen input devices to complete the required data on a selected form.

2. Description of the Prior Art

Various types of pen input devices are known. One type of pen input device is known as a stylus and in particular, an active stylus. Such active stylus are normally used with Tablet PCs as well as various other devices which include a writing surface that is configured to sense electromagnetic energy as well as the location on the writing surface where the electromagnetic energy is directed. The active stylus is used to generate electromagnetic energy which is sensed by the writing surface as the stylus moves there across. Example of such a pen input devices are disclosed in U.S. Pat. No. 6,806,867 and US Patent Application Publication No. US 2004/0125089 A1 to Chao et al.

Other computer systems and pen input devices are known in the art which do not require writing surfaces capable of sensing electromagnetic energy. Examples of such systems are disclosed in U.S. Pat. Nos. 6,577,299; 6,603,464; and 6,633,282; as well as US Patent Application Publication Nos.: US 2002/0011989 A1; US 2002/0163511 A1; US 2004/0125089 A1; US 2004/0140962 A1 and US 2005/0024690 A1. In general, these systems include wireless pen input devices that are linked with a remote computer system and are configured to transmit pen down events including handwriting to the remote computer system for recordation. Various types of such pen input devices are known. For example, optical, inertial and track ball pen input devices are known. Examples of inertial pen input devices are disclosed in US Patent Application Publication No. US 2004/0140962 and 2004/0125089; as well as U.S. Pat. No. 6,577,299. Examples of optical pen input devices are disclosed in US Patent Application Publication Nos.: US 2002/0011989 and US 2005/0024690 and U.S. Pat. No. 6,603,464. Chao et al US Patent Application Publication No. US 2004/0125089 also discloses an optical type pen input device which can also be used as an active stylus. An example of a track ball type pen input device is disclosed in U.S. Pat. No. 6,633,282, all hereby incorporated by reference.

Inertial type pen input devices normally utilize inertial signals from accelerometers to determine the coordinates of the pen input device on an actual or virtual writing surface. For example, Wang et al published US patent application no. US 2004/0140962 A1 discloses a computer system which includes a pen input device for use in both physical ink and non-ink applications. The input device includes an ink cartridge, a pressure sensor, a plurality of accelerometers, a gyroscope, a processor, a memory, a transceiver, a power supply and a display. In non-ink applications, virtually any surface can be used as a virtual writing surface or tablet. In a calibration mode, the system sets the inertial co-ordinates equal to virtual paper coordinates. As the pen input device is moved across a virtual writing surface, inertial signals from the accelerometers are used to calculate the inertial coordinates of the pen input device. The inertial coordinates are used to calculate virtual paper coordinates. In situations where the velocity of the pen input device is constant, the signals from the accelerometers will be relatively inaccurate. In those situations, signals from the gyroscope are used to enhance the accuracy of the inertial signals from the accelerometers. The coordinate signals and thus the path of the pen input device, for example, handwriting, along the virtual writing surface are transmitted to a remote computer system and recorded.

Schiller et al. U.S. Pat. No. 6,577,299 relates to another inertial type pen input device The pen input device disclosed in the '299 patent is configured to wirelessly transmit coordinate signals from the pen input device to a remote computer system. The '299 patent discloses the use of at least two reflectors that are placed along the edges of a piece of paper. A beacon, such as an ultrasonic, infrared, or RF beacon, is located on the pen input device so as to be in communication with the reflectors. The signals reflected from the reflectors are measured to determine their energy and time of flight in order to determine the reference coordinates of the pen input device. Once the reference coordinates are determined, the system utilizes inertial signals from a plurality of accelerometers and a gyroscope to determine the path of the pen input device. As such, the system is able to record handwriting on a virtual or actual writing surface. The beacon is used to periodically calibrate the coordinates of the pen input device.

U.S. Pat. No. 6,633,282 B1 to Monroe discloses a track ball type pen input device. In particular, the '282 patent discloses a track ball located in the tip of the pen input device. The movement of the pen input device across an actual or virtual writing surface is sensed in a similar manner as mouse with a track ball. The pen input device is configured with an outward appearance resembling a standard ballpoint pen which optionally operates as a standard ballpoint pen and as a pen input device. When operated as a pen input device, the position signals of the track ball are transmitted back to the computer system and recorded to record the path of the trackball along the virtual writing surface.

As mentioned above optical pen input devices are also known. US Patent Application Publication No. US 2002/0011989 A1 to Ericson et al is an example of an optical type pen input device. Such optical pen input devices include an optical scanner. An optical way point is used to enable the pen input device to determine its relative position relative to the data, for example, handwriting, to be scanned. The optical way point is provided as a pattern of dots on the writing surface. The pen input device scans the dot pattern and identifies it by conventional optical character recognition (OCR) techniques. As such, the pen input device is able to scan handwritten data and transmit it to a remote computer system along with the paper coordinates of the scanned data. The pen input device is also able to provide various properties to the scanned data, such as, underline, color, line width, yellow mark, secret, and personal and/or by perform an action on the scanned data, such as, encryption, sending an email or facsimile message, etc.

US Patent Application Publication No. US 2002/0163511 A1 to Sekendur is another example of an optical pen input device. That pen input device includes a scanner, such as a digital camera or a charge coupled device (CCD) for scanning optical data, such as handwriting data. With such optical pen input devices, optical way points are provided at one or more specific locations on the writing surface. The pen input device scans and identifies those way points. The way points are used to provide an x-y reference coordinate position so that the movement of the pen input device on the writing surface (e.g., paper) can be referenced to those way points.

US Patent Application Publication No. US 2005/0024690 A1 to Picciotto et al. is another example of an optical type pen input device. In addition to way points, the '690 publication discloses a pen input device which also uses a velocity sensor for sensing speed and relative direction information of the writing tip over a writing surface. Data, such as handwriting data, is scanned by an optical scanner and transmitted to a computer system.

Rabin U.S. Pat. No. 6,603,464 B1 also relates to an optical pen input device for sensing handwriting and other pen down events and transmitting that data wirelessly to a remote computer system. The pen input device is configured to be used with forms to record handwriting or other data physically written on the form. The pen input device includes a scanner for scanning handwriting and other pen down events on special forms which include one or more optical way points at predetermined coordinates on the form. These optical way points are sensed and identified by conventional optical character recognition techniques. The optical way points provide a reference point for the pen input device. As such as handwriting and other data is scanned, the relative position of the scanned data relative to the form is determined relative to the way points. In this application each form to be scanned is divided into a number of fields. Each field is provided with a reference or way point. As such, data in each field on the form along with its reference point. The scanned data is stored in a database and may be used to provide an electronic version of a completed form.

Optical pen input devices are limited to applications where pen input data can be scanned and thus can only be used in physical writing surface applications. As such, optical type pen input devices are becoming increasingly less desirable in paperless office applications. Although track ball and inertial type pen input devices are not so limited in application, many applications, such as medical applications, are still form based. Heretofore, form based applications have only been handled with optical type pen input devices which are limited in application to physical forms. Thus, there is a need for a pen input device for use in a paperless environment.

### SUMMARY OF THE INVENTION

Briefly, the present invention relates to a pen input device and a computer system that is suitable for use with forms in a paperless environment and optionally a paper environment. The pen input device may be configured as an inertial type device so that it can be used on virtual writing surfaces and may optionally be configured to have a selectable ink, pencil and/or eraser mode in which the pen input device can be used as a conventional ball point pen. In accordance with an important aspect of the invention, the computer system is provided with an electronic forms library. These forms are selectable by the pen input device. The pen input device is able to fill out a virtual form on a virtual writing surface and transmit the data to the computer system for recordation. In accordance with another aspect of the invention, the pen input device is provided with enhanced functionality relative to known pen input devices including an electronic erase function and the ability to engage in peer-to-peer communication among multiple pen input devices in an ad hoc or planned network to allow collaboration among multiple pen input devices to complete the required data on a selected form.

### DESCRIPTION OF THE DRAWING

These and other advantages of the present invention will be readily understood with reference to the following description and attached drawing, wherein:

FIG. 1 is a high level diagram of the computer system and the pen input device in accordance with the present invention.

FIG. 2 illustrates an exemplary virtual form for use with the present invention.

FIG. 3 is a diagram illustrating the calibration technique in accordance with one aspect of the invention.

FIG. 4 is a diagram of the software architecture of pen input device for performing pen to paper calibrations.

FIG. 5 is a more detailed diagram of the of the calibration algorithm illustrated in FIG. 4.

FIG. 6 is a block diagram of the pen input device in accordance with the present invention.

FIG. 7 is an exemplary schematic diagram of the pen input device illustrated in FIG. 6.

FIGS. 8 and 9 illustrate an exemplary configuration for a database for use with the present invention.

FIG. 10 is a diagram illustrating an exemplary data format for data transmitted by the pen input device.

FIGS. 11-17 illustrate exemplary web pages for a web based implementation of the present invention.

FIG. 18 is a configuration diagram of an exemplary network configuration for the system in accordance with the present invention.

FIG. 19A is a block diagram of a client/server configuration for the system in accordance with the present invention.

FIG. 19B illustrates a centralized peer-to-peer configuration for the system in accordance with the present invention.

FIG. 19C illustrates a decentralized peer-to-peer configuration for the system in accordance With the present invention.

FIGS. 20A and 20B represent a software flow diagram or a pen input device configured for peer-to-peer operation in accordance with the present invention.

FIG. 21 is a flow chart illustrating the on/off operation of a pen input device in accordance with the present invention.

FIG. 22 is a software flow chart illustrating the NEW_PAGE mode of the pen input device in accordance with the present invention.

FIG. 23 is a software flow diagram of the calibration mode logic for a pen input device in accordance with the present invention.

FIGS. 24A-24C illustrate software flow diagrams for converting raw analog position data of the pen input device to digital data.

FIGS. 25A-25E illustrates software flow diagram for converting the accelerometer data to X, Y position data for the pen input device in accordance with the present invention.

FIG. 26 is a software flow diagram for an embodiment of a web application of the system in accordance with the present invention.

FIG. 27 is a software flow diagram for a file transfer web application in accordance with the present invention.

FIG. 28 is a software flow diagram of a form groups web application in accordance with the present invention.

FIGS. 29A-29D are software flow diagram for a forms definition web application in accordance with the present invention.

### DETAILED DESCRIPTION

The system in accordance with the present invention relates to a pen input device and a computer system that is suitable for use with forms in a paperless environment, for example, on a form template and optionally a paper environment. The pen input device may be configured as an inertial type device so that it can be used on virtual writing surfaces and may optionally be configured to have a selectable ink mode in which the pen input device can be used as a conventional ball point pen. In accordance with an important aspect of the invention, the computer system is provided with an electronic forms library. These forms are selectable by the pen input device. The pen input device is able to fill out a virtual form on a virtual writing surface and transmit the data to the computer system for recordation. In accordance with another aspect of the invention, the pen input device is provided with enhanced functionality relative to known pen input devices including an electronic erase function and the ability to engage in peer-to-peer communication among multiple pen input devices in an ad hoc or planned network to allow collaboration among multiple pen input devices to complete the required data on a selected form.

### System Overview

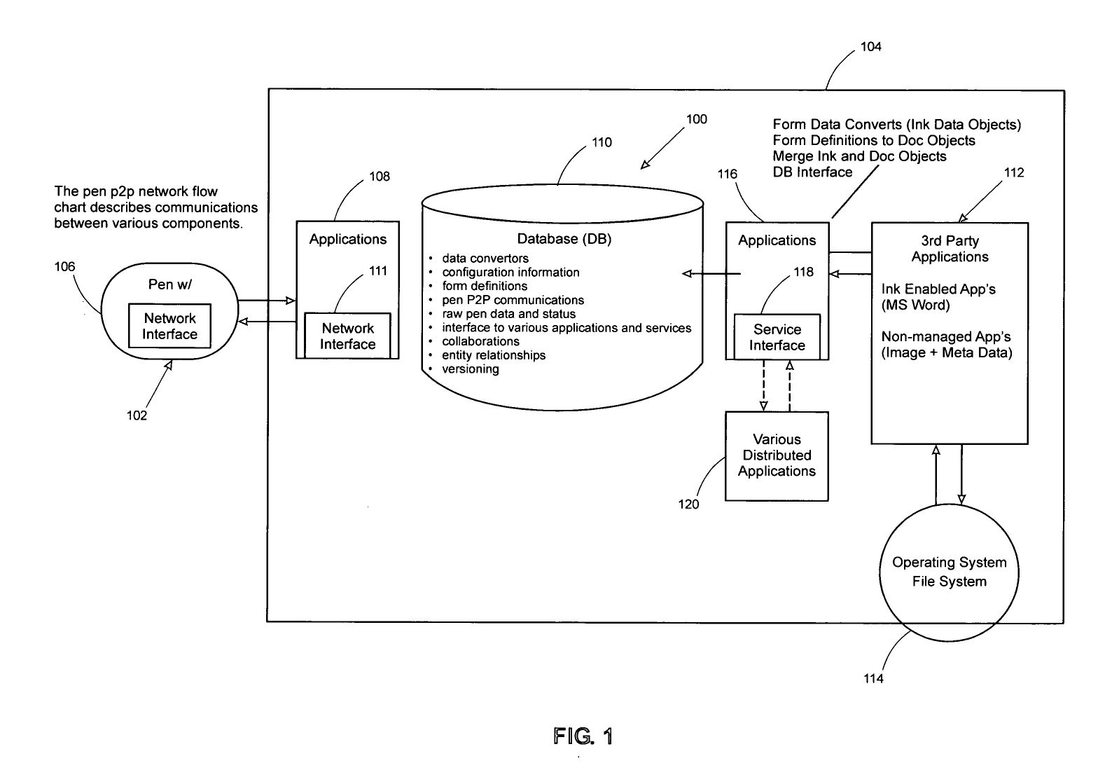

Referring to FIG. 1, a high level diagram of the computer system and pen input device in accordance with the present invention is illustrated and generally identified with the reference numeral 100. The system 100 includes at least one pen input device 102 and a computer system, which may be a tablet PC, shown within the box 104. Various operating modes for the system 100 are contemplated. In a master slave mode, a single pen input device 102 acts as a slave to the computer system 102. In a multiple pen input device 102 environments, the pen input devices 102 may be configured to communicate with each other on a peer-to-peer basis as well as with the computer system 104 by way of a network interface 106. Although the computer system 104 is normally considered to be the master, operating environments which include a large number of pen input devices 102 can have multiple masters.

Each pen input device 102 in the network must be configured. Each pen input device 102 has a minimum two unique ID's. In particular, each pen input device 102 comes with default settings. These settings include the following:

Unique ID of the Pen

Unique ID of various components on the Pen P2P

To communicate with another pen input device 102, the sending pen input device 102 verifies that the receiving pen input device 102 has a unique ID that is listed in the pen configuration stored in the computer system 104. The receiving pen input device 102 also verifies that the unique ID of the sending pen input device 102 is loaded in its configuration information. If both of these comparisons are true, communication is enabled between the two pen input devices 102.

There are several exemplary ways to add a new unique ID's to the configuration information of a pen input device 102.
Downloading new configuration from the master computer system
To trade unique ID's after asking the user to accept the unique ID's
To trade a temporary unique ID that allows communication for a group of transactions (e.g., exchanging form information for collaboration)

The first way is for a master component, such as the computer system 104, to download new unique ID into configuration information of a pen input device 102. In this case, the master (i.e. computer system 104) and the pen input device 102 verify that they can communicate with each other (i.e. establish a wireless communication link). The master then downloads new configuration information to the pen input device 102. The new configuration information contains unique ID's. Alternatively, a pen input device 102 can poll or search (e.g., wireless network) for other pen input devices 102 and ask other pen input devices 102 in the network if it can communicate in the manner discussed above. If so, a communication link is established (also known as a hand shake), two options are available as set forth below. The ability of the pen input devices 102 to communicate with each other has various benefits, such as the ability to trade notes with meeting members and also provides for strict network definitions based on organization policies.

The pen input device 102 may be provided with an electronic erase function. In particular, the electronic erase functionality works in a similar manner as the pen input device in an ink mode. That is, whenever the user makes a mark on a writing surface, the pen input device 102 logs the position data. In an erase mode, the system operates in essentially the same way. Specifically, anytime the user writes on a writing surface using the pen input device 102, the system records the position data for the path of the pen input device 102 on the writing surface. A force sensor or position switch is used to indicate that the writing end ink of the pen input device 102 is pressed to the writing surface. An optional force sensor or position switch may also be used to indicate an opposing or eraser end of the pen input device 102 is pressed against the writing surface.

In an electronic eraser mode, the user turns the pen input device 102 over and presses the eraser to the writing surface. As the user erases the physical markings, the device logs the eraser's position information just like when the device is actually making marks on the surface. The difference being that the device logs the eraser's position switch status INSTEAD of the cartridge/lead switch status. This is accomplished by using difference position switches. Electronic erasing occurs when device's data is converted to form data. Electronic erasing is done by (a program) deleting position (pencil markings) information that corresponds to eraser position data. The device is configured for different eraser sizes. That means that the eraser's position data may be, for example, x,y+/−5-25 mm. Any position information of inking within the eraser's data range is thus removed from the final form data. This insures that all the electronic marks are removed from the form, therefore, accomplishing electronic eraser of data. The user may then write in the erased area like it is a blank part of a form.

The pen network interface 106 may also be configured to interface the pen input device 102 to other computer systems and miscellaneous devices, such as cell phones. The network interface 106 may be used to establish communication links on a wired or wireless basis. The pen network interface 106 is also used to download small programs (e.g. Java applet) to provide additional functionality, such as provide the ability of the pen input device 102 to email pen form information or provide an application that may connect to, for example, a peer-to-peer network of pen input devices 102 The application may also provide functions, such as, emailing and interfacing to enterprise applications.

The pen network interface 106 may be configured so that the pen peer-to-peer network software rides on top of standard network protocols, such as Ethernet, wireless IEEE 802.11b, Bluetooth, wireless USB as well as other conventional network protocols. The network interface 102 may be configured to support encryption, such as RSA encryption technology or other standard or non-standard encryption techniques. Like any peer-to-peer network, the pen-to-pen network may be a local network or distributed, for example, the Internet. The network interface 102 to connect the pen input device to gateways to allow communication with other peer-to-peer networks. The principles of the present invention are applicable to both ad hoc and planned networks.

The pen input devices 102 communicates with the computer system 104 by way of application software 108, which may be resident on a single computer system, or distributed across multiple systems over, for example, the Internet. In particular, the computer system 104 includes a network interface 110 for interfacing with one or more pen input devices 102, as well as other computer systems, connected, for example in a local area network (LAN) as well as to gateways to communicate with other peer-to-peer networks.

The computer system application software 108 includes the following software components: configuration, forms definition, device groups, forms groups as well as a database interface. Each of these software components is discussed below.

The “Configuration” software component relates to the configuration of each type of pen input devices 102 in the network. Although only a single type of pen input device is described herein, the system can accommodate different types of pen input devices 102 which have different numbers of buttons and LEDs, etc. The configuration software component stores a default configuration for the pen input devices 102, which is modifiable by the user. In addition, the configuration software component causes the following information to be stored for each pen input device 102 in the peer-to-peer (P2P) network.
Unique ID for the pen
Unique ID for each device, computer, pen, etc. that the pen can communicate with over the P2P
Number of forms supported
Form type tied to form number
Form definition disabled
Number of calibration points (this ties the digital form to the actual size of the paper)
Sensor Update Rate
Form Document Collaboration disabled
Sensor sample rate
DAC algorithm
Roll compensation enabled
X, y, and time position storing rate
Form data send enabled
Form data received disabled
Form meta definitions
P2P network search disabled
Exchange Unique ID's with a P2P device, computer/tablet pc, etc.
Send/receive status information
Eraser disabled
Force Sensor disabled
Text messaging disabled
Etc.

The “Forms Definition” software component includes specific information about each form in a forms library. In particular, the form definition is the digital definition of a paper form. A blank writing space is called a blank form. A digital definition of a form with different sections/fields (e.g., Doctor's patient record) is also a form. Each type of form is given a unique name and number and the maximum number of pages. For example, a blank form could be form #1 in a pen. Form 1 could have a maximum number of pages say 40. Forms can be defined on a computer/tablet pc or via a pen. Form definitions via the pen are accomplished using the form calibration functionally.

A function can be linked to a form or area/field within a form. The function-to-form may be classified as a type of form. When the form definition is transmitted to a pen input device 102 that recognizes the type, a predefined action is accomplished. This could be as simple as sending a text message to a pager or as intricate as a web service that interfaces with a company's Enterprise Response Planning (ERP) system. The Pen P2P network enables functionality that can integrate with various components and provide functionality that is much better than existing technology.

As mentioned above, the system is amenable to various network configurations. The “Device Groups” software component maintains the unique IDs of the various pen input devices in the network. This software component also gives the pen input devices 102 the definitions to enroll in the network.

The “Forms Group” software component keeps tracks which of the various forms available in the forms library are downloaded to specific pen input devices. This software component is also responsible for downloading form definitions to the various pen input devices 102 and receiving information from the pen input devices 102 and storing the data from the pen input devices 102 in an appropriate field in a database for later processing of a filled out form.

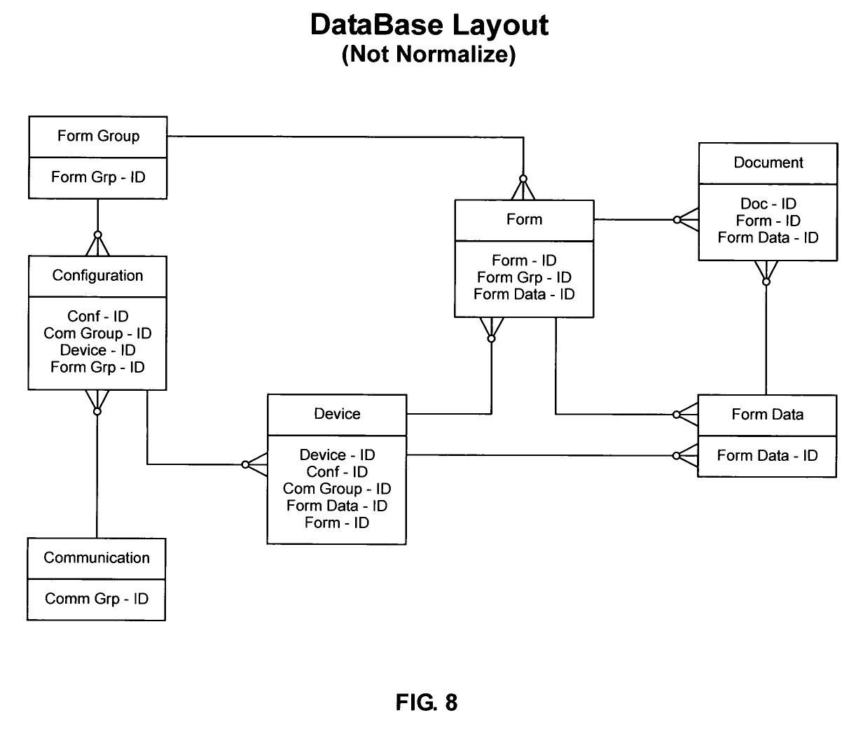

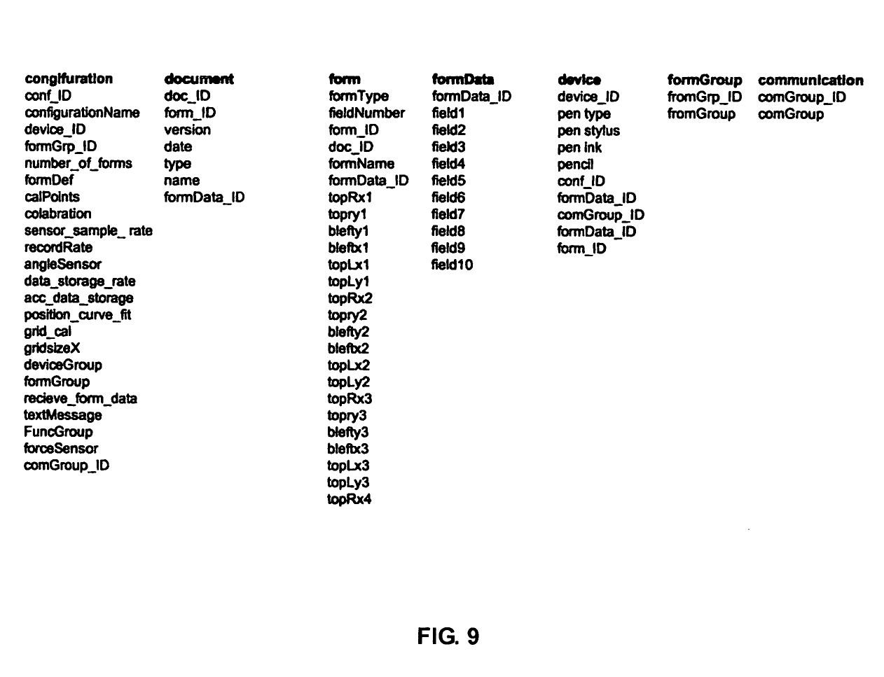

The application software 108 also includes a “Database Interface” software component. The “Database Interface” software component is for interfacing with a database 110. The database 110 may be resident on the computer system 104 or resident on a separate computer system or distributed. The database is a data store for many applications, such as the configuration and form definition applications. The database 110 also acts as a data store for various data, such as: raw position data, pen P2P communications; raw pen data and status; collaborations, entity relationships and versioning. An exemplary layout for the database 110 is illustrated in FIGS. 8 and 9. Alternatively, a file system could be used for storage.

Once a form is filled in, it needs to be converted to a useful format (e.g., digital ink for use on a computer system application). This converted form also needs to be converted back into a format that the pen input device 102 can use. This re-conversion can take place after an ink enabled application modifies the documentation. To enable conversion and communication, the pen input device 102 stores form information with time and position. The information can be sent to other components either in raw form or in a converted form. Additional information could be the various calibration points, form number, number of pages, etc. An example of conversion is when the form information is sent to a computer/tablet pc. The form information can be stored, converted to any number of ink formats (e.g., digital ink), converted to a document, written on via the computer system 104, converted back to form information, transmitted to one or more pen input devices 102 where a hardcopy(s) of the document may be marked on and the cycle repeats itself. What is important is the conversion to various formats that can be used on other applications, the resending to the pen, the pen doing its operations, then transmitting the information to various components on the pen P2P network.

Various third party off the shelf applications 112 are used to convert ink data and form definitions to document objects. For example, form data and form definitions from the database 110 may be converted to document objects using Microsoft Word and document/Windows objects, available on the operating system 114. For ink data, the third party off the shelf applications 112 support both ink-enabled and non-ink enabled applications. In non-ink enabled applications, the ink data can be used as information data from the XML application or embedded like an OLE. Forms are treated separately from ink data. As such, the ink data information is overlaid on top of the form. A back end application interface software component 116 is used to provide an interface with the database 110 and also act as a go between for accessing the database 110 and transferring ink data and form definition data to the third party application software components 112. The back end application interface software component 116 also receives the converted form document from the third party application software components 112. The form document may then be emailed, faxed or sent, for example, over the Internet, by way of a service interface 118 to one or more resident or distributed applications 120. The various functions may be offered over the Internet, for example, to companies, individuals, etc.

### Exemplary Form

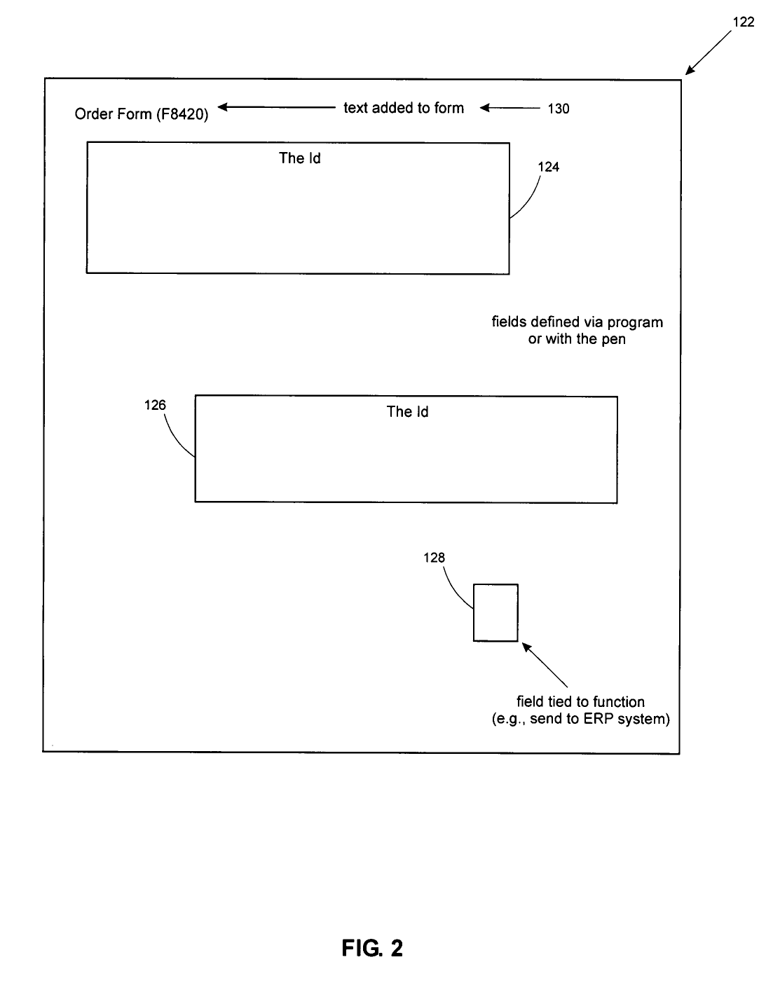

An exemplary form is illustrated in FIG. 2 and generally identified with the reference numeral 122. Each form 122 may include one or more data fields 124, 126, as well as a function field 128, as discussed above. The form may also include text, generally identified with the reference numeral 130, outside of the outside of the fields 124, 126 and 128. Each form 122 is assigned a type and a number. The field definitions and functions tied to each form are also identified. The form definition is saved separately from the data. Data can be entered into the data fields by way of the computer system 104 with standard text or by digital ink applications by way of one or more pen input devices 102, as discussed above.

### Calibration

If a digital form is not linked to a writing surface, the data is useless. Therefore, a calibration mechanism is provided. The form calibration provides several functions:
Define the top edge and left side of the writing surface
Using three or four calibration points or more, the boundary of the writing surface is defined. The form is then scaled to the paper size. For example, a blank form could be 8.5′×11.5″ or 14″×17″ or any other size given the sensor technology used to implement the pen hardware platform.
When no calibration is done, the outer edges of where the pen is used are recorded and a paper size is selected based on standard paper sizes. Of course, this can be adjusted.
When the form definition mode is selected for the pen, the selected fields are recorded relative to the calibration events. This is an easy way to define or convert existing paper forms to digital information.
The form calibration is also used when a user stops using the pen and then wants to continue using the pen on the form again. The user can either calibrate by using one point on the top edge and left side of the writing surface or calibrate from the last point writing on the surface.
The real-time calibration is also used to allow various sensing technology to be used. This is accomplished by defining a physical point on the writing surface that the relative sensors can measure from to calculate x, y positions on the writing surface. Each major physical point is defined relative to a virtual grid.

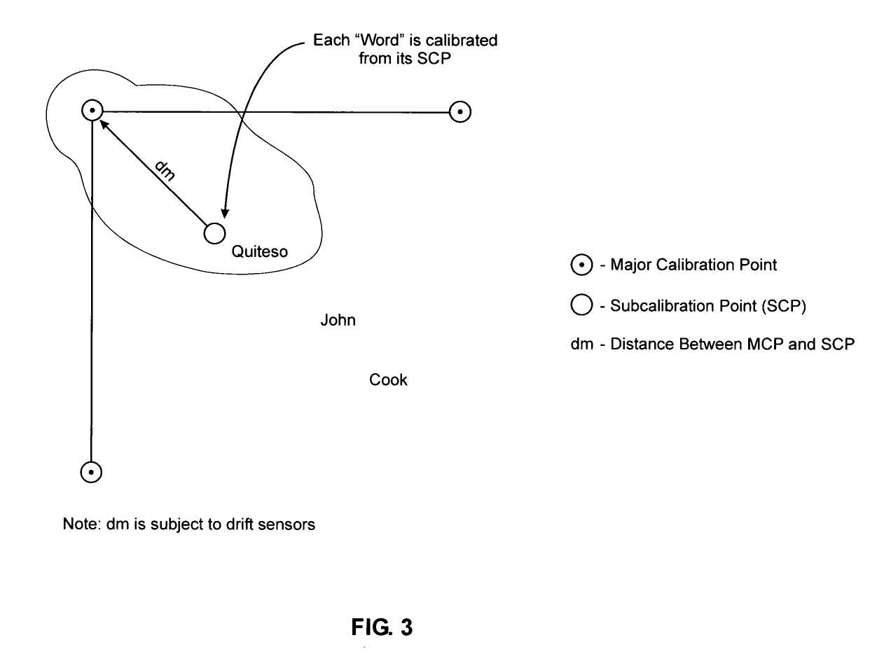

One of the problems with using certain sensors to make relative measures is measurement errors. Drift errors are a major component of measurement errors. For example, acceleration sensors accumulate drift error with use without a calibration. Current state-of-the-art sensor technology has greatly reduced drift errors but not enough to make its use in a pen viable for many applications. As such the calibration technique in accordance with the present invention overcomes these limitations. Specifically, it eliminates the need for absolute measurements from a variety of beacon implementations, for example as disclosed in Rabin U.S. Pat. No. 6,603,464. FIG. 3 illustrates an augmentation to the form calibration functions describe above.

The form calibration functions still work as indicated. However, to reduce drift errors in various implementations, sub-calibration points (SCP) can be performed at each writing point. As illustrated in FIG. 3. The number of major calibration points (MCP) and the parameter calibration points may have a variable frequency. A writing point is defined as a point that occurs when a user starts to make a mark on the writing surface. In this implementation, the writing point is also a SCP.

The distance between a MCP and a SCP is subject to drift errors. These errors can accumulate enough to make the use of acceleration sensors not viable. But by treating the distance between MCP and each SCP as a rough measurement and the SCP as a very fine measurement, the drift errors can be reduced to overcome the measurement error problems. Optionally, each MCP can be linked with virtual grid points on the work space. This enables a finer rough measurement. The grid points may be as large as the whole writing surface. This is made possible by a user's natural writing style. For example, assume a user starts writing on a writing surface within a 5 mm area. It is not all that important to know if this initial mark is +/−2 mm either way. But what is important, is that measurements taken from the initial mark are within a much tighter tolerance, say 0.5 mm. This means that the system can use a wider tolerance for an MCP initial placement and make further measures more accurate from the initial course measurement. The practical advantage is that sensors with drift issues can be “rezeroed” while the user naturally writes, thus overcoming the constant increase in drift errors that would make the position measurement too inaccurate for many applications.

Also a variety of digital to analog converter (DAC) algorithms can be used in conjunction with the above calibration schemes to further reduce errors. Such DAC algorithms cover several categories. The basic DAC algorithms are all within the ordinary skill in the art and may include
analog filtering
oversampling
averaging of sample (3000 Hz signal is reduced to a 600 Hz signal by averaging)
using standard curve fits from manufacturer's calibration coefficients.
Doing a 10 point calibration with the pen for the full-sale x,y measurements on a typical writing surface. This compensates for linearity and hysteresis errors.

The above algorithms can be used to further reduce the coarse (or major calibration) point errors relative to a writing surface. By reducing the coarse readings, the measurement error is well within a user's natural writing style. On the other hand, the measurements relative to each course reading are inaccurate enough to be used with various recognition software packages.

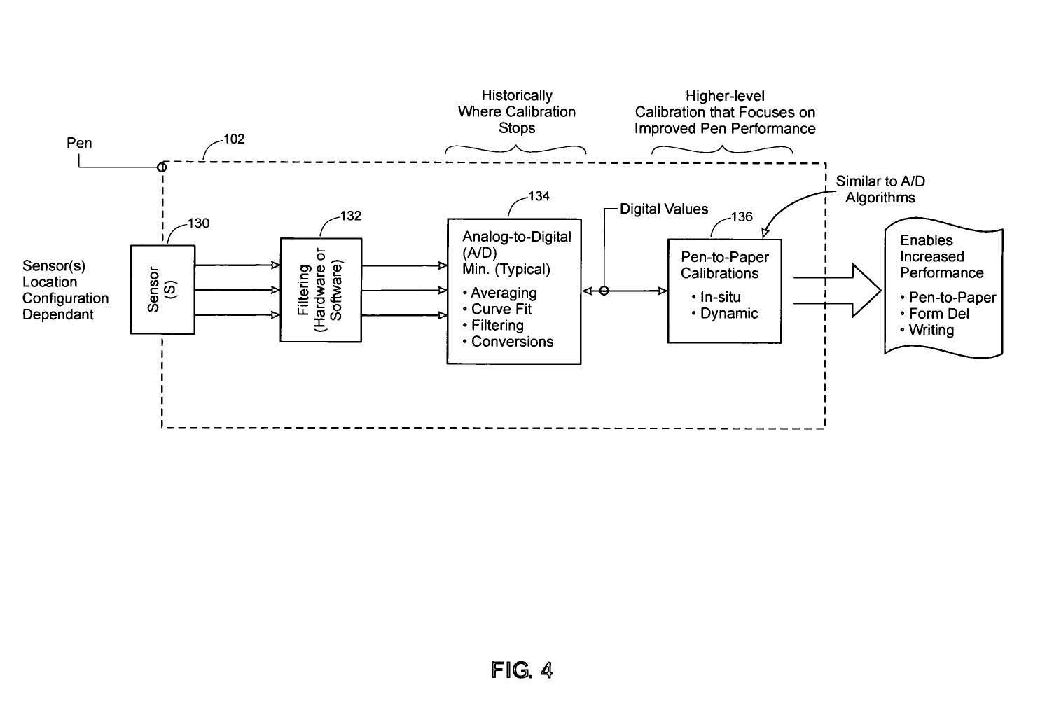

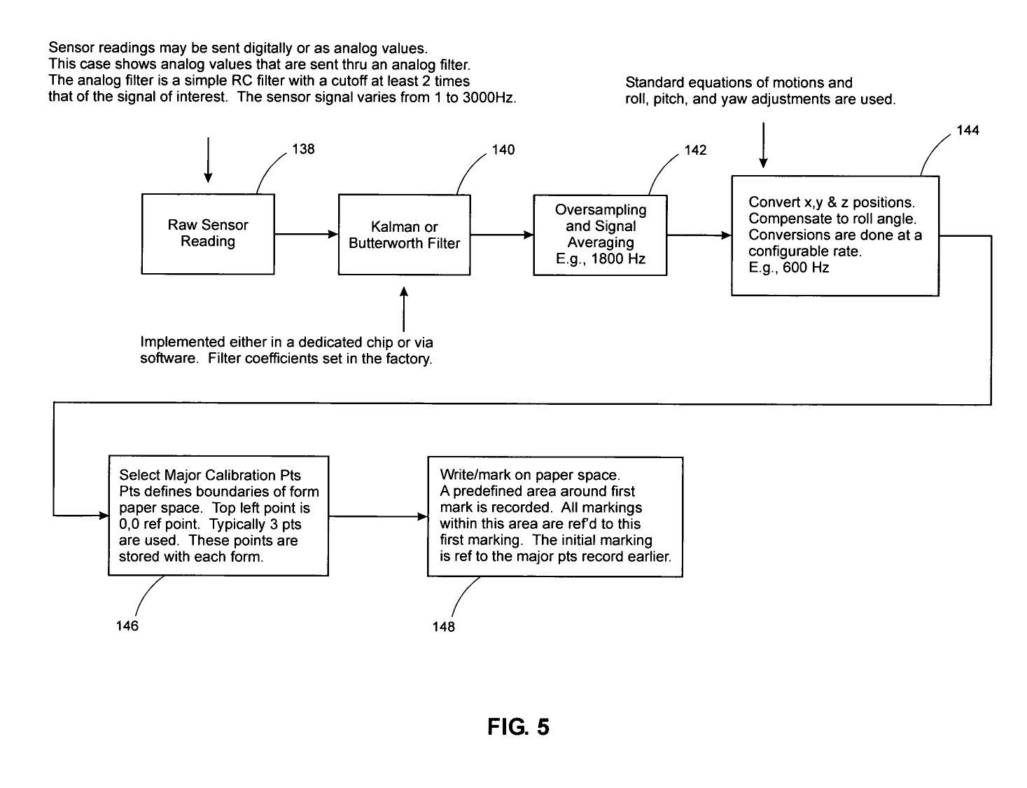

The pen to paper calibration is done locally and optionally may be done via a program in the computer system by the pen input devices 102. The calibration algorithm is illustrated in FIGS. 4 and 5. FIG. 4 is a general data flow diagram of the pen input device 102 while FIG. 5 is more detailed. Referring first to FIG. 4, the pen input device 102 includes a sensor 130 raw pen data. As indicated above, the sensor 130 can be virtually any type of non-optical sensor, such as an inertial type sensor or a track ball sensor. Initially the raw sensor data is filtered. The raw sensor data is analog. This raw sensor data may be further processed as analog data or digital data. If processed as analog data, the raw sensor data may be filtered with standard hardware. Alternatively, the raw sensor data could de converted to digital form by way of an analog to digital converter and filtered by way of a digital filter. Assuming the signals are being processed in analog form, the analog signals are converted to digital form by an analog to digital converter (ADC) 134. The digital values from the ADC 134 are then used for pen to paper calibrations which, as discussed above, include in situ calibration, as well as dynamic calibration.

A more detailed data flow diagram of the calibration algorithm is illustrated in FIG. 5. Initially, raw sensor readings 138 are received from the sensor 138. As shown, the raw sensor readings are initially processed as analog data that is filtered by a simple RC filter with a cut-off twice the frequency of the signal frequency. In the case of the pen input devices 102, the signal frequency is expected to vary from 1 to 3000 Hz. As mentioned above, the raw sensor readings may also be converted to digital form and filtered by a digital filter. The digital filter, for example, a Kalman or Butterworth filter, can be implemented in software or by way of a dedicated integrated circuit with factory set coefficients. The filtered signals are then digitized by an ADC 142, for example, the on-board ADC on an MPS430 model microprocessor which has a 12-bit delta sigma ADC included. The pen input device includes triaxial mounted accelerometers as well as an angle sensor. The raw data from the triaxial mounted accelerometers and the angle sensor are converted to x, y, z position data of the pen input device 102 using standard equations of motion which include adjustments for roll, pitch and yew. Exemplary equations are provided below.

$$\begin{matrix} rotation about Z \text{-} axis \\ ↓\end{matrix}$$

$$Xacceleration = Aacceleration * cosine ( {Gyro}_{z} ) - Yacceleration * sin ( {Gyro}_{z} )$$

$$\begin{matrix}Pitch = & & arctangent [ \frac{Xacceleration}{{[ {Yacceleration}^{2} + {Zacceleration}^{2} ]}^{1 / 2}} ] \\ Roll = & & arctangent [ \frac{Yacceleration}{{[ {Xacceleration}^{2} + {Zacceleration}^{2} ]}^{1 / 2}} ] \\ \begin{matrix}Xacceleration \text{-} adjusted = \\ ( ACCXIADJ )\end{matrix} & & \begin{matrix}Xacceleration * cosine ( pitch ) + \\ YAcceleration * sine ( roll ) * sine ( pitch ) - \end{matrix} \\ & & Zacceleration * cosine ( roll ) * sine ( pitch ) \\ \begin{matrix}Yacceleration \text{-} adjusted = \\ ( ACCYIADJ )\end{matrix} & & \begin{matrix}Yacceleration * cosine ( roll ) + \\ Zacceleration * sine ( roll ) \end{matrix} \\ & & ACCXI = ACCxIADJ \\ Velocity \to & & Vx = Vxo + ACCXI * DE \text{-} T DEL \text{-} T ∼ change in time per sample \\ & & Average Vx ( AVEVx ) = ( Vx + Vo ) / 2 \\ & & Delx = AVE Vx * DEL \text{-} T \\ & & ↑ \\ & & change in X position \\ & & X = Xo * DELX \\ & & ↑ \\ & & position ↑ initial X position \\ & & ACCXO = ACCXI \\ & & ↑ \\ & & new initial acceleration is current ACCXI \\ & & Vxo = Vx \\ & & ↑ \\ & & new initial V is current Vx \\ & & Xo = X \\ & & \begin{matrix}↑ \\ new initial X position is current position \\ repeat above for Y ( position ) \end{matrix}\end{matrix}$$

The x, y, z position data is determined in step 144 and is optionally compensated for roll angle. Translation along the x-axis may be needed based on the sensor location within the pen input device 102. The conversion rate may be configurable and done, for example at 600 Hz. Next in step 146, parameters are selected. These points define the boundaries of the form paper space. For example, the top left corner of the form may be used as the 0,0 reference point. Three points may be selected and stored for each form. Otherwise default reference points are used, as discussed above. In step 148, sub-calibration is performed as discussed above. In particular, the pen input device 102 is used to mark or draw on the form. A predefined area around the first mark is recorded and defined as a major-calibration point. All markings within the predefined area are referenced to the major-calibration point. As discussed above, the sub-calibration point is referenced to the major calibration points discussed above.

### Pen Input Device

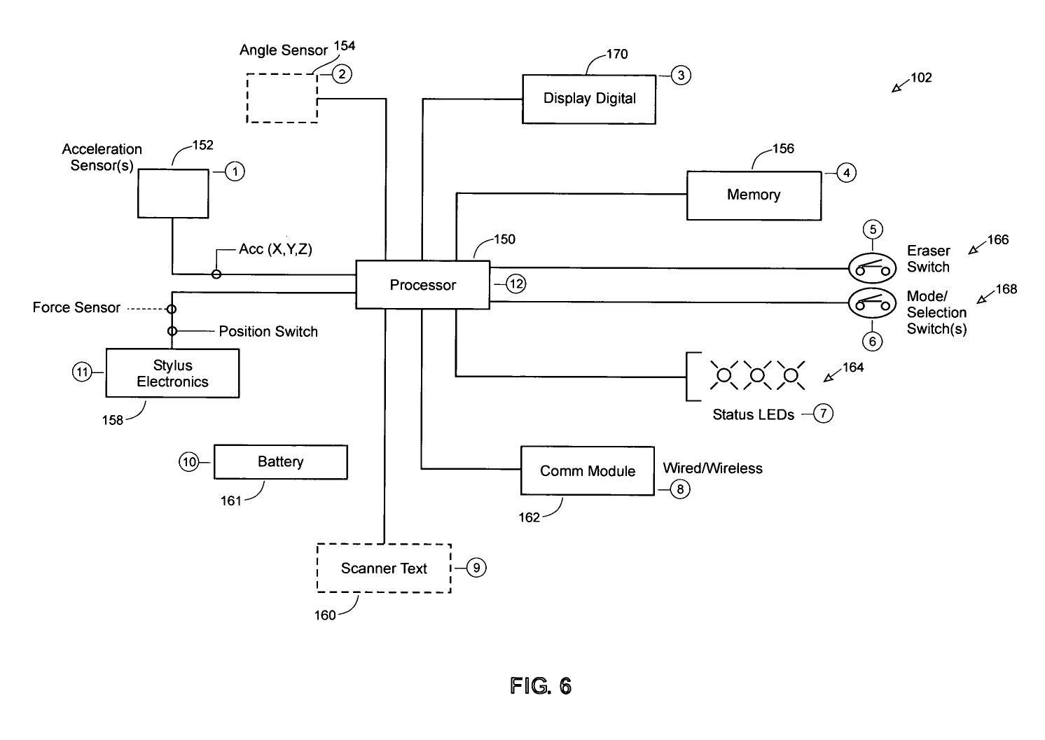

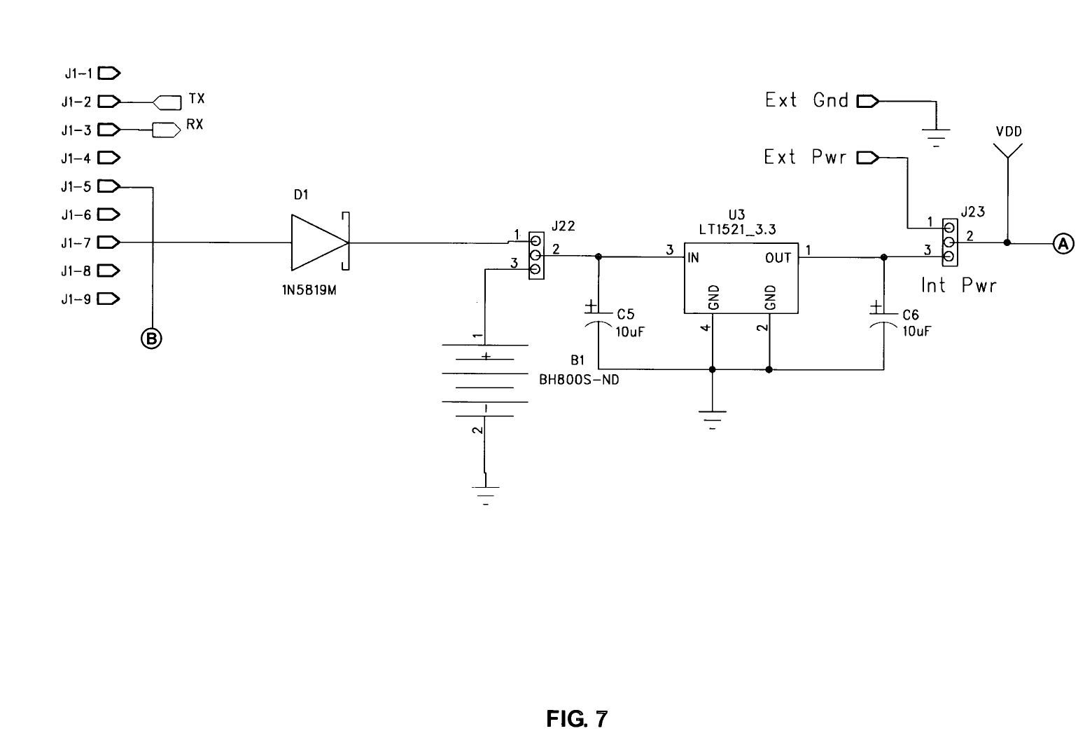

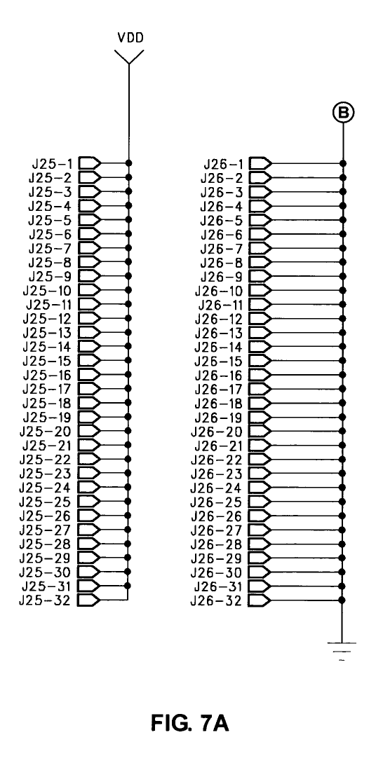

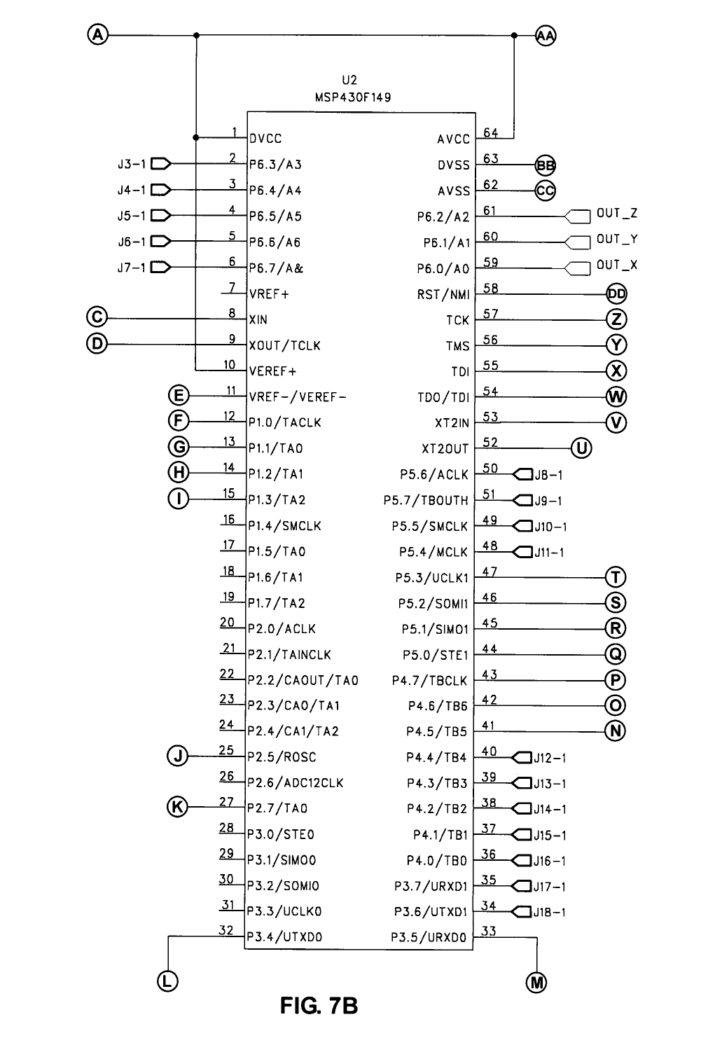

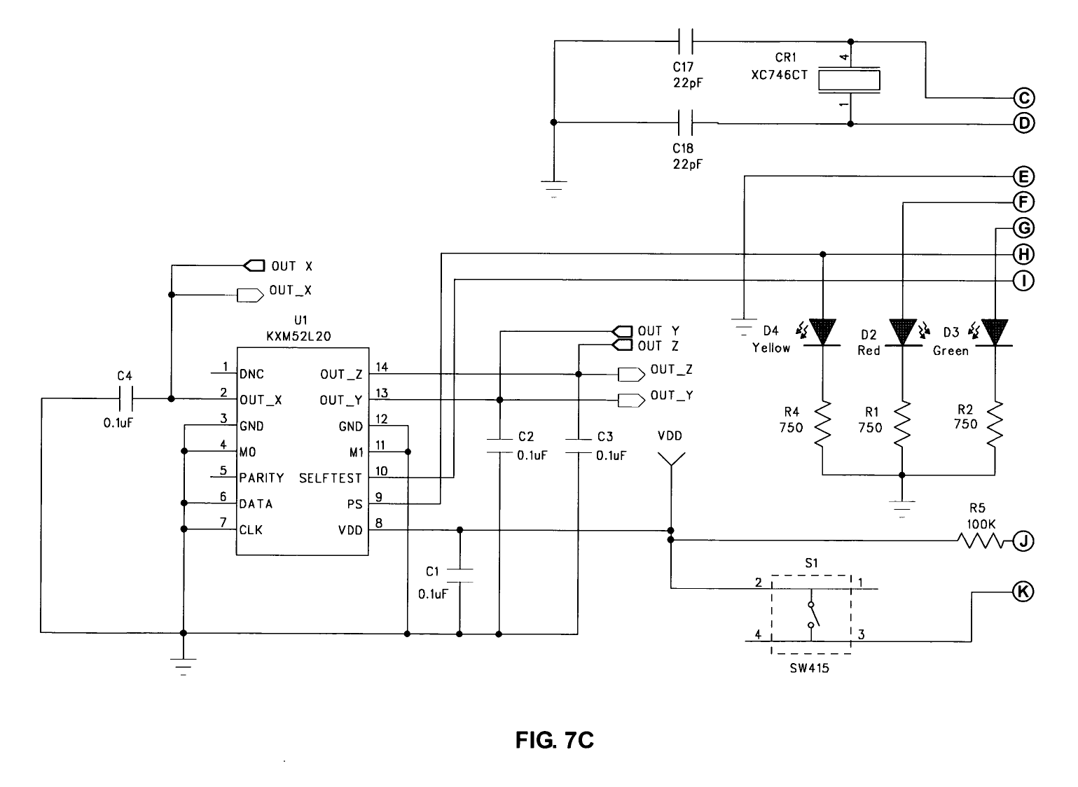

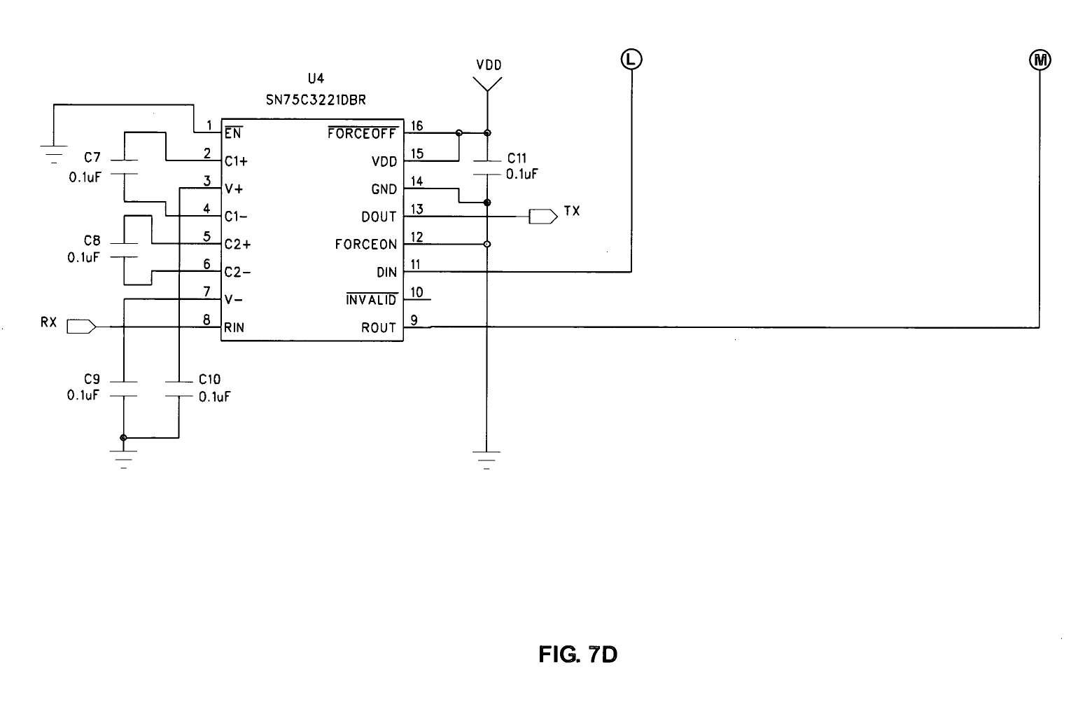

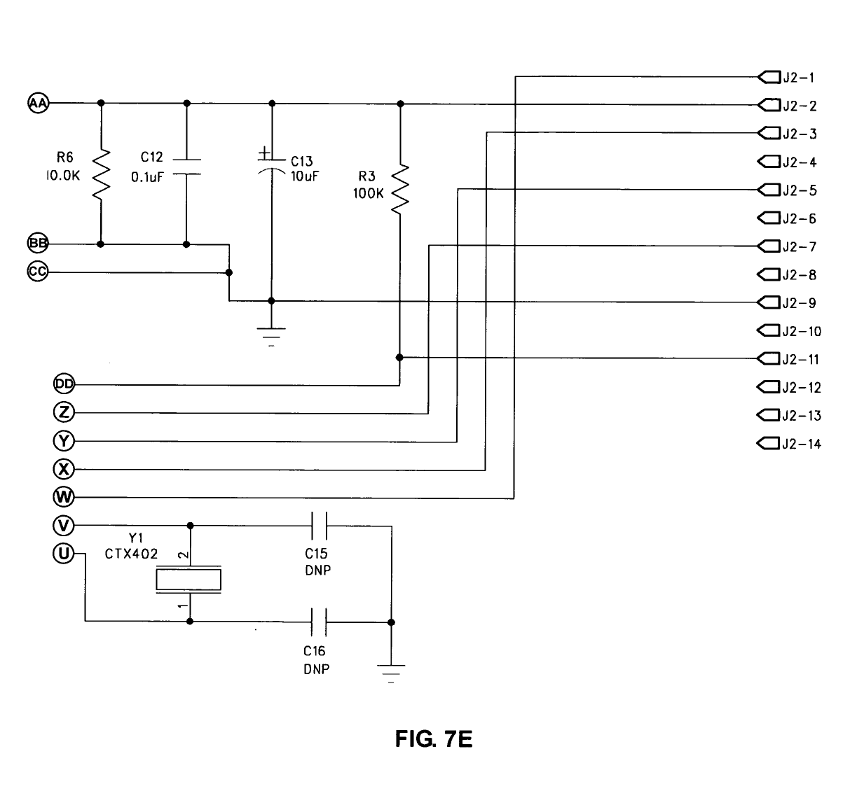

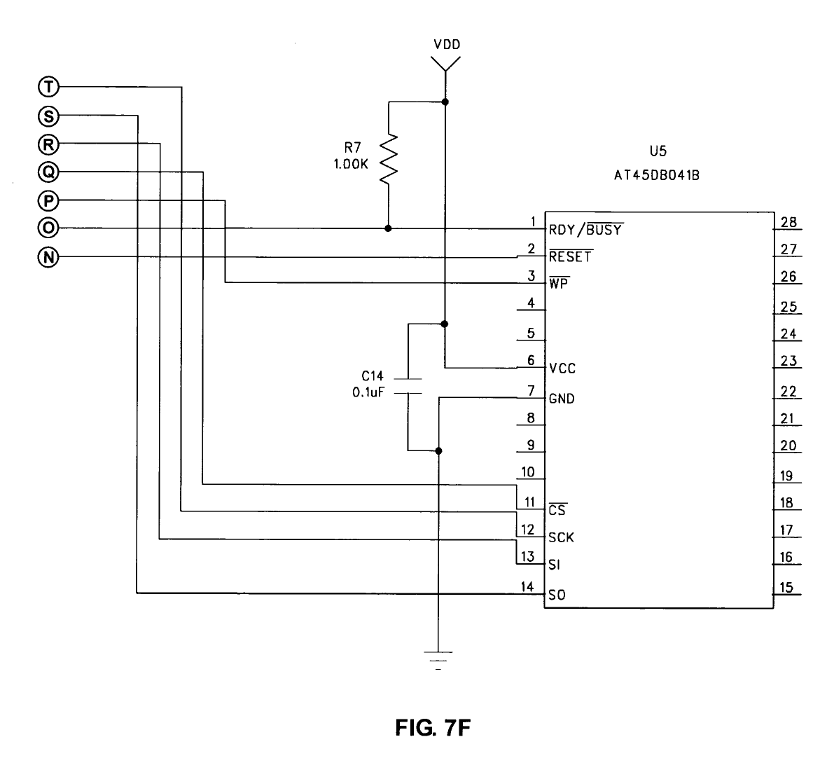

FIG. 6 is an exemplary block diagram of the pen input device 102, while FIG. 7 is an exemplary schematic diagram. Referring to FIG. 6, the pen input device includes a processor 150, acceleration sensors 152, an angle sensor 154, memory 156, an optional stylus electronics 158, an optional scanner 160, a battery 161, a communication module 162, which may be wired or wireless, status LEDs 164, an optional eraser switch a mode selector switches and push buttons 168 and a display. Exemplary components for these devices are as follows:
152: Kionix KXM52 MEMS Tri-Axis Acceleration Sensor—x,y only can be used in certain configurations.
154: Kionix Gyroscope (optional).
170: Generic miniature digital display (optional).
156: Amtel AT45DB041B 4 Mbit flash memory. Memory size may vary (other manufacturers may be substituted).
166: Generic simple pushbutton switch (optional).
168: Same as 166.
164: Generic status LED's (optional).
162: Communication module wired USB, serial, etc. Various wireless supported.
160: Text scanner module (optional).
161: 6VDC supply voltage. Not required if USB wired configuration is used (other power supplies and power levels may be needed based on actual parts used).
158: WACOM Compatible Stylus with position switch (force sensor is optional).
150: Texas Instruments MSP430F149 Processor (other processors may be substituted).

The implementation illustrated in FIGS. 6 and 7 supports the following:
Sensor bandwidths up to 3000 Hz
Position resolution from 2 mm to 0.01 mm
Over sampling with filtering, averaging techniques, etc. resulting in an overall throughput (analog signal to converted digital signal) from 0 Hz to 1200 Hz
Major and sub-calibration that allows relative sensors to be used
Wireless and/or wired communication to other computers, pens, misc. devices (e.g., cell phones). Security is provided with unique ID's and RSA encryption technologies (if required). Supports peer-to-peer interfacing.
Various memory sizes depending on number of written pages/forms. Note: 128 kbytes supports approximately 40 written (full) pages.
Multiple electronic stylus/ink pen/pencil/erasers/scanner configurations

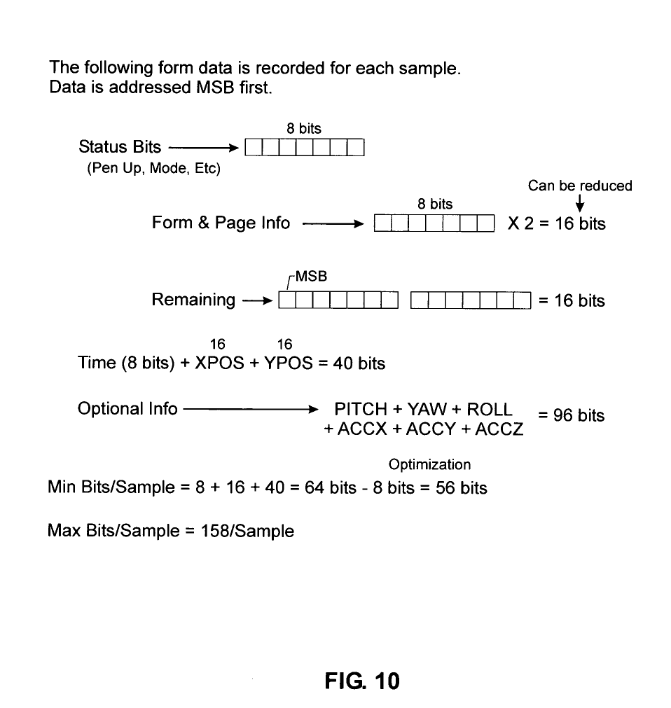

The main memory of the processor 150 is given address range OFFFFh-01000h. The configuration file and program are stored in flash memory. The external memory is used for data. The data recorded for each sample is illustrated in FIG. 10.

The operation of the pen input device 102 is described in connection with a three pushbutton interface. However, other pen interfaces are also considered to be within the scope of the invention. The three pushbutton interface includes a first pushbutton PB1 that is pressed to start writing on a NEW_PAGE. A second pushbutton PB2 is pressed when a new calibration is required. The third pushbutton PB3 is toggled to turn the pen input device on and off (e.g., simple switch normally used to indicate that a ball-point pen is extended may be substituted).

The initial configuration for the pen is as follows:
Unique ID for the pen is set
Unique ID for each device, computer, pen, etc. that the pen can communicate with over the pen P2P is set
Number of forms supported is set to 3
Form type linked to form number forms 1 and 2 are blank forms and form 3 is a function (email) form
Form definition disabled
Number of calibration points is set to 3
Sensor Update Rate is set to 1800 Hz
Form Document Collaboration is disabled
DAC algorithm is set to running average
Roll compensation is enabled
X, y, and time position storing rate is set to 600 Hz
Form data send enabled
Form data received enabled
Pen P2P network search enabled
Exchange Unique ID's with a P2P device, computer/tablet pc, etc. is disabled
Send/receive status information
Eraser disabled
Force Sensor disabled

After the user toggles the pushbutton PB3 to turn the pen input device on, the pen input device loads the initial configuration and defaults to a default form and the calibration mode and the last form page used when the using the pen input device 102.

The pen input device has three modes of operation, selectable by the mode selection switches/pushbuttons 168 (FIG. 6): an on/off mode; a calibration mode; a write mode, and optionally an erase mode. As discussed above, in the calibration mode, three parameter points are required in order to calibrate the form to the writing surface. As mentioned above, the pen input device 102 may initially default to the calibration mode after the pen input device is turned on. In a calibration mode, the user presses the pen input device on three points of the writing surface to initialize the major calibration points.

After the digital form is linked to the physical form, the user may start writing. The user may start a NEW_PAGE by pressing the NEW_PAGE pushbutton. The user may upload pen data to the computer system 104, for example, any time any one of the pushbuttons PB1, PB2 or PB3 are depressed after the connection is enabled. In web applications, as discussed below, the data from the pen input device 102 may be uploaded by way of a web host. After each page (or complete device memory with several forms and form data) is completed by the user, the user selects the pushbutton PB1 which causes the data for the completed page to be transmitted to the computer system 104 by way of the communication module 162 (FIG. 6) and configures the system for a NEW_PAGE. After the last form is completed, the pushbutton PB1 is selected for a NEW_PAGE to transfer the form data as mentioned above. The pushbutton PB3 is then toggled to turn off the pen input device 102. The current mode of the pen input device is displayed on the display 170.

As mentioned above, the pen input device includes LEDs 164 for status indication. For example, three LED's may be provided on the pen input device 102. The LED's 164 are all different colors. For descriptive purposes, the LED's are blue, green, and white. The following are the default settings of each LED.
The green LED is turned on when the pen is on. The green LED flashes when the pen's memory is full. The green LED stops flashing when the pen's memory is no longer full. Then turns on again to indicate the pen is ready for use. The “full” level can be set at different levels (e.g., % of total memory).
The blue LED flashes when the pen needs to be calibrated. The blue LED is solid when the pen is sending/receiving information. The Blue LED is off when all the information is sent/received.
The white LED flashes when information is being sent or received and stops flashing after the information have been sent/received. This verifies that the information is accepted.

### File Format

There are several file formats that can be used to communicate from application to application. None of the standard formats deal with a pen type device working separately from a digitizer. An exemplary format for use with the present invention is Ink Markup Language Draft as the format for its pen like device and application to application information exchange. Refer to the proposed inkXML standard for details. Just replace the notion of a digitizer/computer information exchange with a pen like device to computer to digitizer to application information exchange.

Below is some basic information that is translated from the standard. In its simplest form, an exemplary InkML file with its enclosed traces is shown below:

<ink>

<trace>

10 0 9 14 8 28 7 42 6 56 6 70 8 84 8 98 8 112 9 126 10 140
13 154 14 168 17 182 18 188 23 174 30 160 38 147 49 135
58 124 72 121 77 135 80 149 82 163 84 177 87 191 93 205

</trace>
<trace>

130 155 144 159 158 160 170 154 179 143 179 129 166 125
152 128 140 136 131 149 126 163 124 177 128 190 137 200
150 208 163 210 178 208 192 201 205 192 214 180

</trace>
<trace>

227 50 226 64 225 78 227 92 228 106 228 120 229 134
230 148 234 162 235 176 238 190 241 204

</trace>
<trace>

282 45 281 59 284 73 285 87 287 101 288 115 290 129
291 143 294 157 294 171 294 185 296 199 300 213

</trace>
<trace>

366 130 359 143 354 157 349 171 352 185 359 197
371 204 385 205 398 202 408 191 413 177 413 163
405 150 392 143 378 141 365 150

</trace>

</ink>

These traces consist simply of alternating X and Y values.

The following name attributes are reserved. These attributes translate nicely for use with a pen input device. Extensions can be made within the XML standard to accommodate the pen input technology.

The following channel names, with their specified meanings, are reserved:

| channel | |
|---|---|
| name | interpretation |
| X | X coordinate (horizontal pen position) |
| Y | Y coordinate (vertical pen position) |
| Z | Z coordinate (height of pen above paper/digitizer) |
| F | pen tip force |
| S | tip switch state (touching/not touching the digitizer) |
| B1 . . . Bn | side button states |
| Tx | tilt along the x-axis |
| Ty | tilt along the y-axis |
| A | azimuth angle of the pen (yaw) |
| E | elevation angle of the pen (pitch) |
| R | rotation (rotation about pen axis - i.e., like the roll |
| | axis of an airplane) |
| T | time (of the sample point) |

Not all the above information is used in a stylus/digitizer implementation. However, using the standard for the pen input device technology enables a greater integration with various applications and therefore increases the value-add in a business like implementation. As such, the file format is well grounded allowing the use a W3C standard as a baseline.

### Web Application

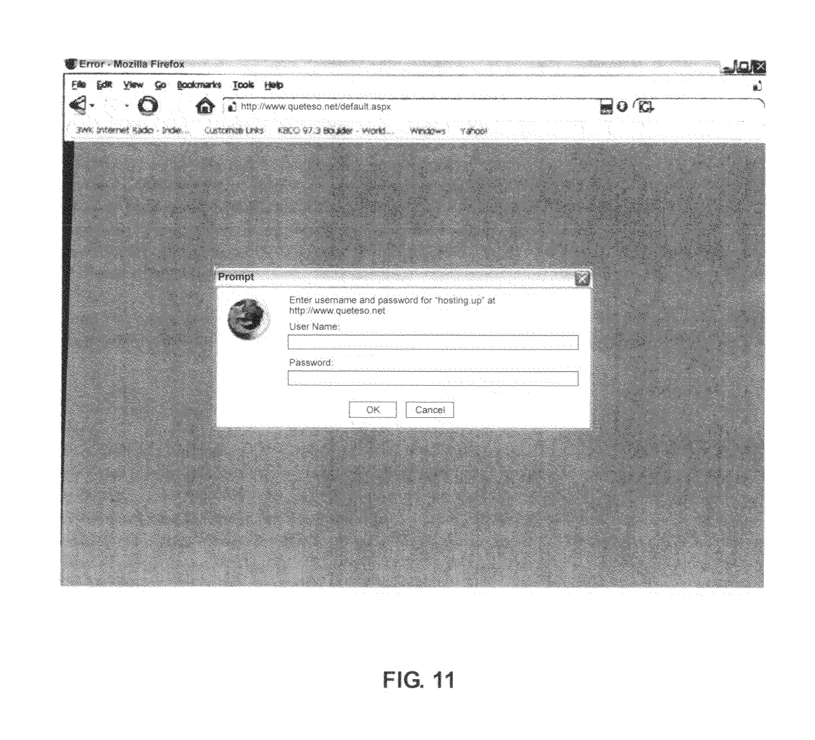

FIGS. 11-17 illustrate exemplary web pages for an optional web-based implementation of the present invention. Initially, a user launches a web browser and types the appropriate URL to get to the log in page illustrated in FIG. 11.

### Upload Device Data

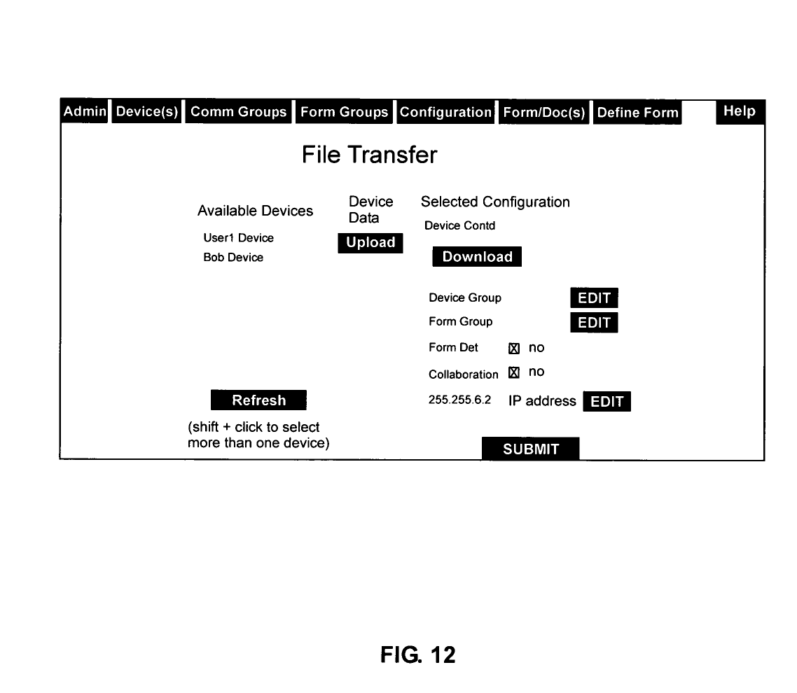

After the user successfully logs in, a File Transfer web page, as illustrated in FIG. 12, is launched. The File Transfer page indicates what devices are connected to the network in an “available devices list.” The list is adapted to be updated by clicking on a refresh button. The File Transfer page may be used to upload device data and also download configuration data to a device. Also, the File Transfer page enables various information, such as device group, form group and IP addresses to be edited. After the edits are made, a Submit button is selected which causes the edits to be stored on the database 110.

To upload form data from the device, the user simply:

selects the device from the device list

clicks on the upload device data button

The user is then prompted for the file storage location.

The conversion process may be automated by having a known directory. The user is able to copy or move files to the directory. The directory may be a webshare directory. Once the file is placed in the directory, an application to merge the file to a format that is accepted by various pen-enabled applications.

A configuration name is displayed when a user selects a device. The user then has the following options:
click on the download button to send the configuration information to the selected device
edit configuration information by selecting the edit buttons of clicking on the toggle button
save the configuration changes by pressing the submit button. The configuration name has not changed but the change would impact another device.

### Creating/Changing a Form Group

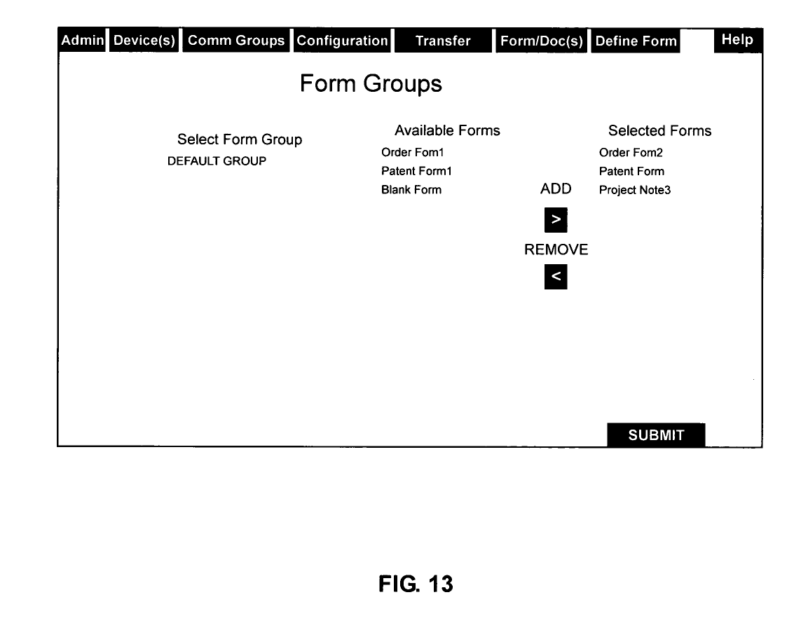

A Form Groups page, illustrated in FIG. 13, may be selected by selecting the Forms Group button on any other page. The Form Groups page is used to define a form group. A form group is a name given to a group of forms.

In order to create or change a form group, the user does the following:
selects a form group from the drop-down menu or types in a new form group name.
forms available/defined are listed as well as the current forms that are associated with a form group.
forms may be added or removed by selecting a form and clicking on the add/remove button as needed.
The changes are saved when the user clicks on the submit button.

### Creating/Changing a Device Group

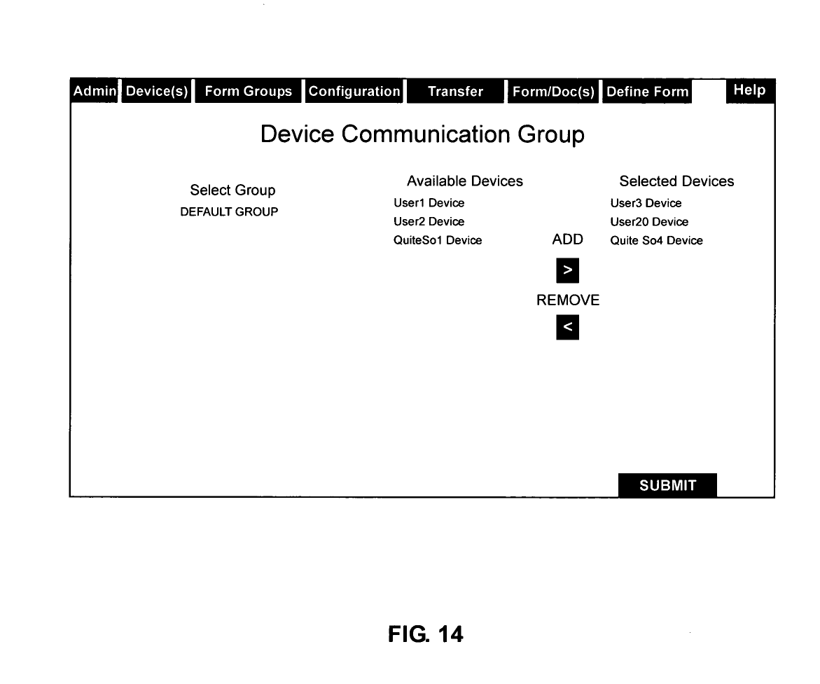

The Device Communication Group page is illustrated in FIG. 14. This page may be reached by selecting the Communication Groups navigation button on any other page. The main purpose of the Device Communications page is to define a communications group. A device group is a name given to a group of devices that can communicate with each other In order to create or change a device group, the user does the following:
select a device group from a drop-down menu or type in a new device group name.
The devices that are available are listed as well as the current devices that are associated with a device group.
Devices may be added or removed by selecting a device and clicking on the add/remove button as needed.
The changes are saved when the user clicks on the submit button.

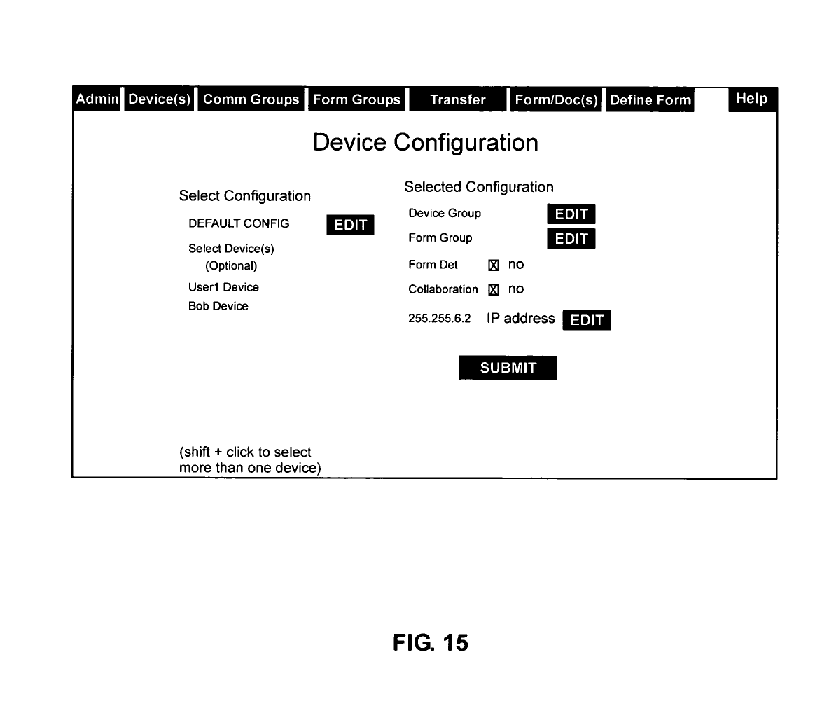

A Device Configuration page is illustrated in FIG. 15. The Device Configuration page may be reached by selecting a configuration button from another page. The main purpose of the Device Configuration page is to create or change the configuration and associate the configuration with a device.

### Creating/Changing a Configuration Name

The configuration name is displayed when the user selects a device. The user then has the following options:
edit configuration information by selecting the edit buttons or clicking on the toggle buttons.
If desired, select the device that is associated with a particular configuration.
Save the configuration changes by pressing the submit button. The configuration name is changed if the change would not impact another device.

### Enabling/Disabling Pen Input Devices

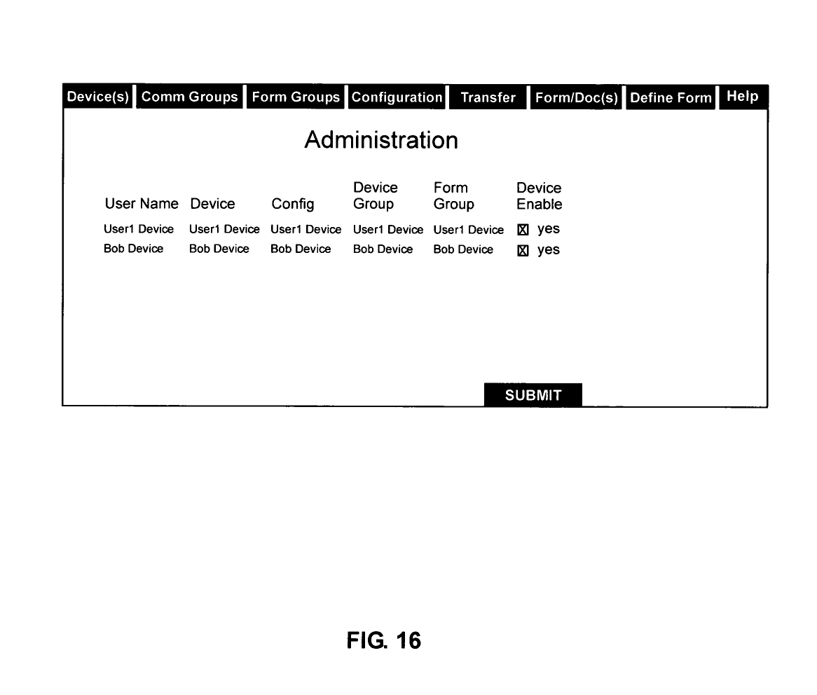

An administrative page is illustrated in FIG. 16. The administrative page may be reached by selecting the administrative button on any other page. The main purpose of the administration page is to enable a user to enable and disable pen input devices 102.

### Form Definition

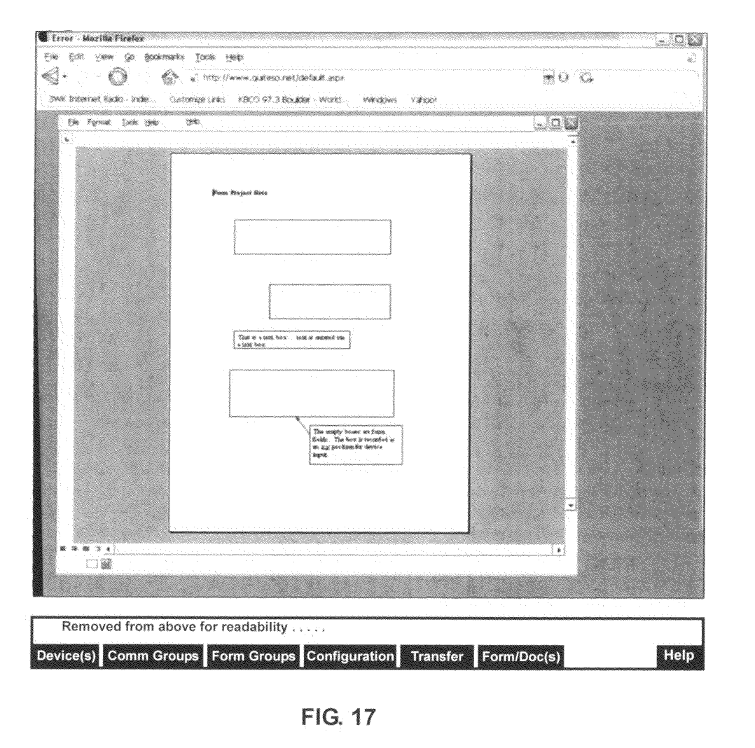

FIG. 17 illustrates a Form Definition page. The Form Definition page may be reached by selecting a form definition button on another web page. The main purpose of the form definition page is to create/or change a form. After the form is defined and saved, it is given a form number. The fields are converted to x, y positions and stored in a database. A copy of the presentation is saved as well. Later, the form data may be mapped to each defined field and overlaid on top of the forms so that the user can view and modify all information on the form. Also, different field data from the form may be provided to different applications.

### Configuration

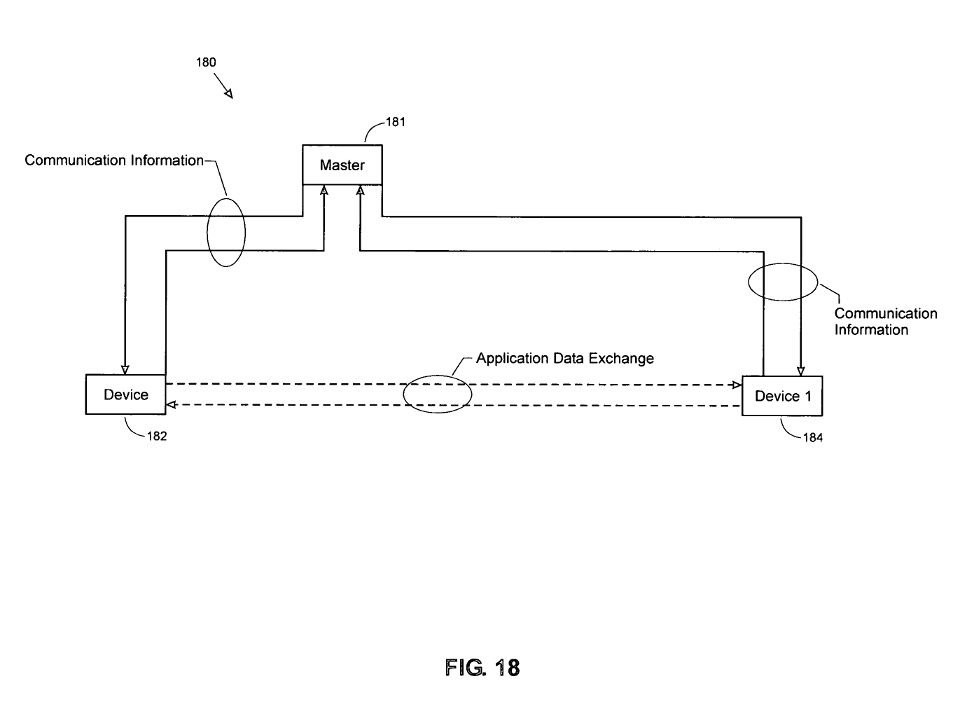

FIG. 18 is a configuration diagram of an exemplary network configuration for the system in accordance with the present invention. The computer system is generally identified with the reference numeral 180 and includes a master 182 as well as two pen input devices 182 and 184. In this particular configuration, the master has the following functions:
Keep a list of pen input devices and their respective IP addresses.
Each pen input device sends a “here I am” message to the master every x seconds, for example, one second. The pen input devices send a URL. The master logs the device and IP address in order to keep the IP addresses current.
When a device wants to communicate with another device, the master sends the necessary IP name combination to allow a connection.
Each pen input device has a list of devices and IP addresses to which it can communicate. This information (device names) is contained in the configuration file. Each device sends a “here I am” message to the master every x seconds. The pen input device also sends a URL to the master along with its IP address and credentials.

When a device wants to talk to another device, it sends the device name to the master 182. The master 182 sends back the device name and IP address. Each pen input device 102 will then have a direct connection with another one by way of the known IP address. The sending pen input device 102 sends its name and credentials to the receiving pen input device 102. The receiving pen input device responds to the sending device with its name and credentials. This establishes a communication handshake which allows the pen input devices 102 to communicate with each other. The sending device queries the receiving device to find out what functions it can provide.

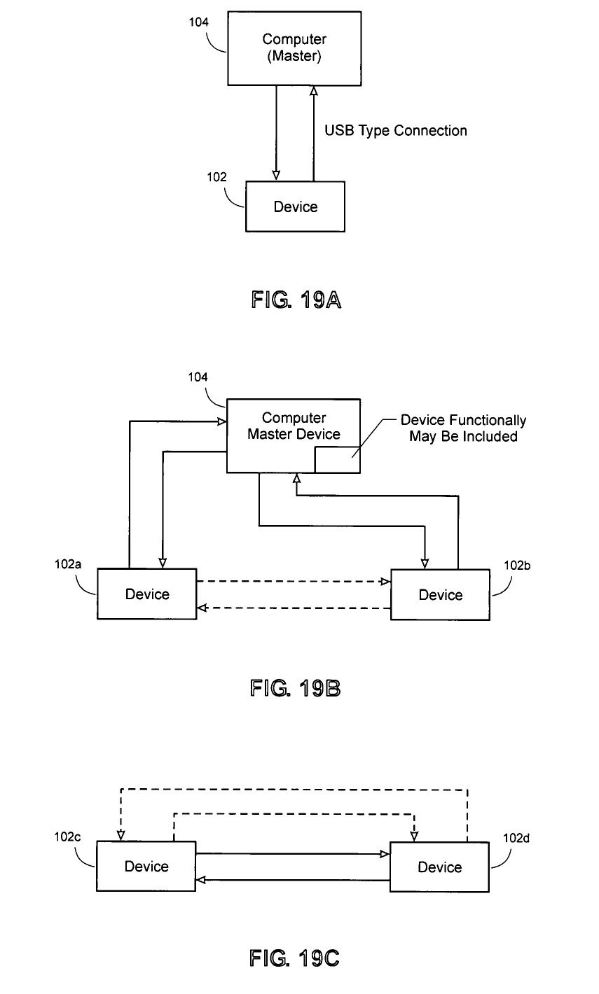

FIGS. 19A-19C illustrate various operating configurations for the pen input device in accordance with the present invention. In particular, FIG. 19A illustrates a client/server configuration. In this configuration, a single pen input device 102 may be configured as a client to a computer system 104. As shown, the computer system 104 and pen input device 102 are provided with bidirectional communication.

FIGS. 19B and 19C illustrate a configuration with multiple pen input devices. In FIG. 19B the pen input devices are maybe configured for centralized peer-to-peer operation. In this configuration, the computer system 104 acts as a master and polls to find other to other pen input devices 102 available for communication and organize devices connection information. Once the master 104 has validated the various pen input devices 102 the master 104 advises the various pen input devices 102 that they have been validated and can now communicate with each other. The pen input devices can then exchange communication independently of the master 104.

FIG. 19C is a diagram illustrating a decentralized peer-to-peer configuration in accordance with the present invention. In this configuration, the “masters” functions are distributed within each pen input device 102. Also a broadcast response may be used for pen input devices for communications sessions

### Flow Charts

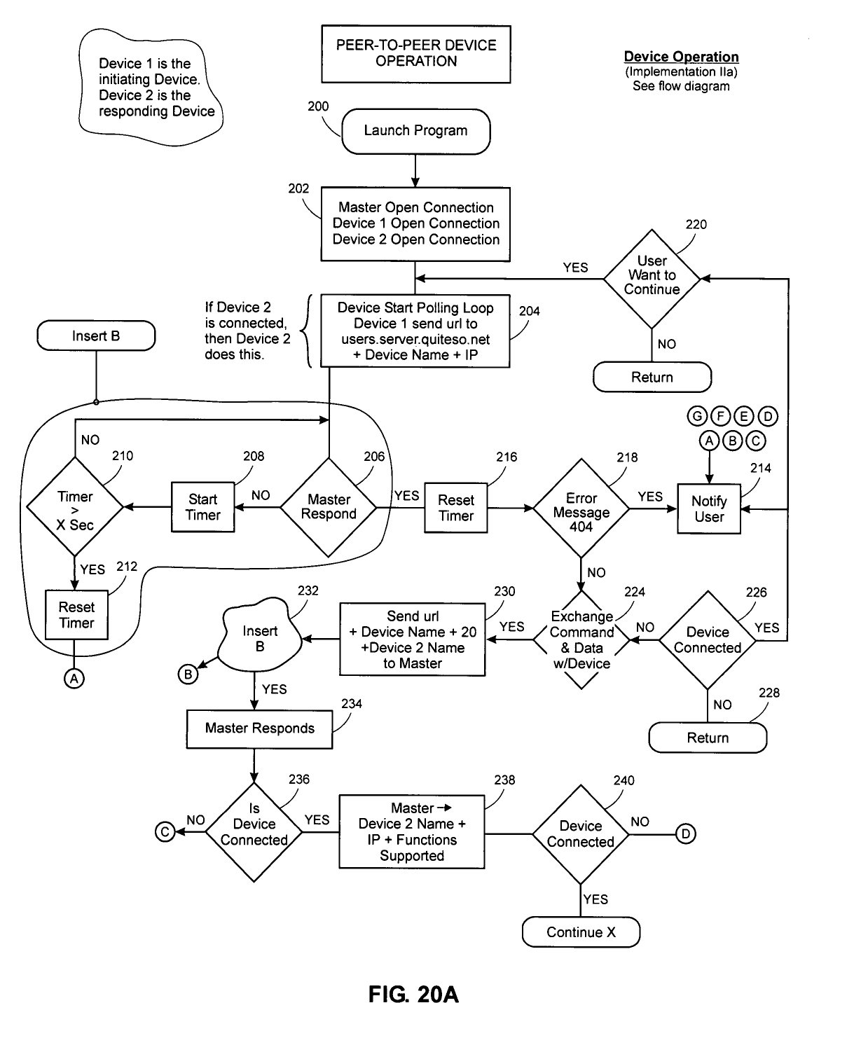

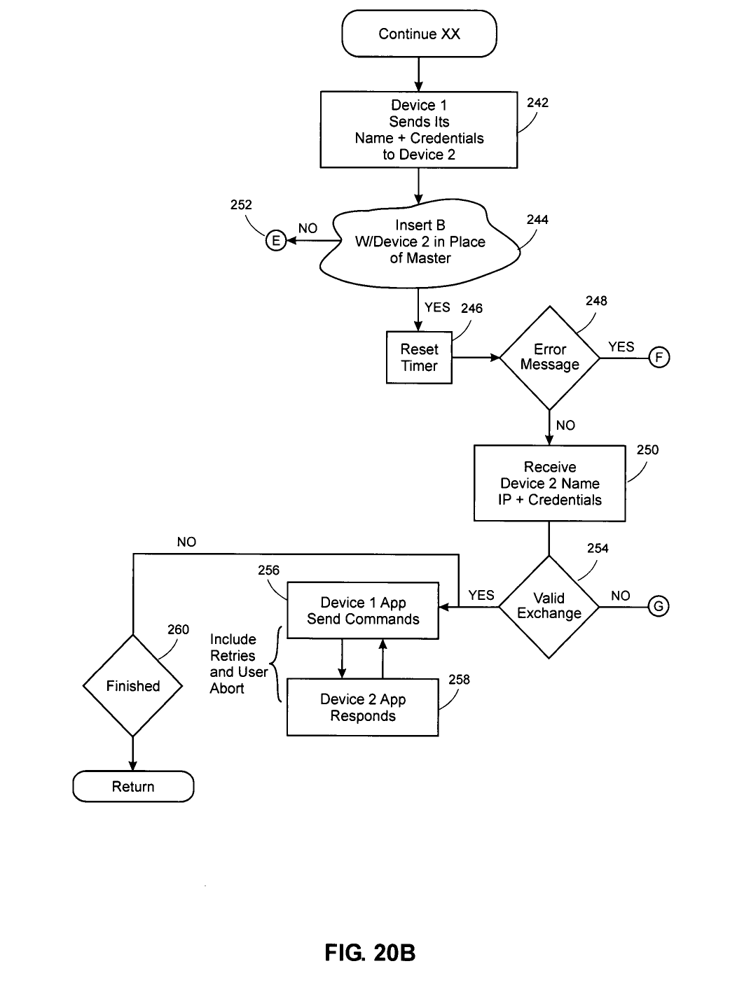

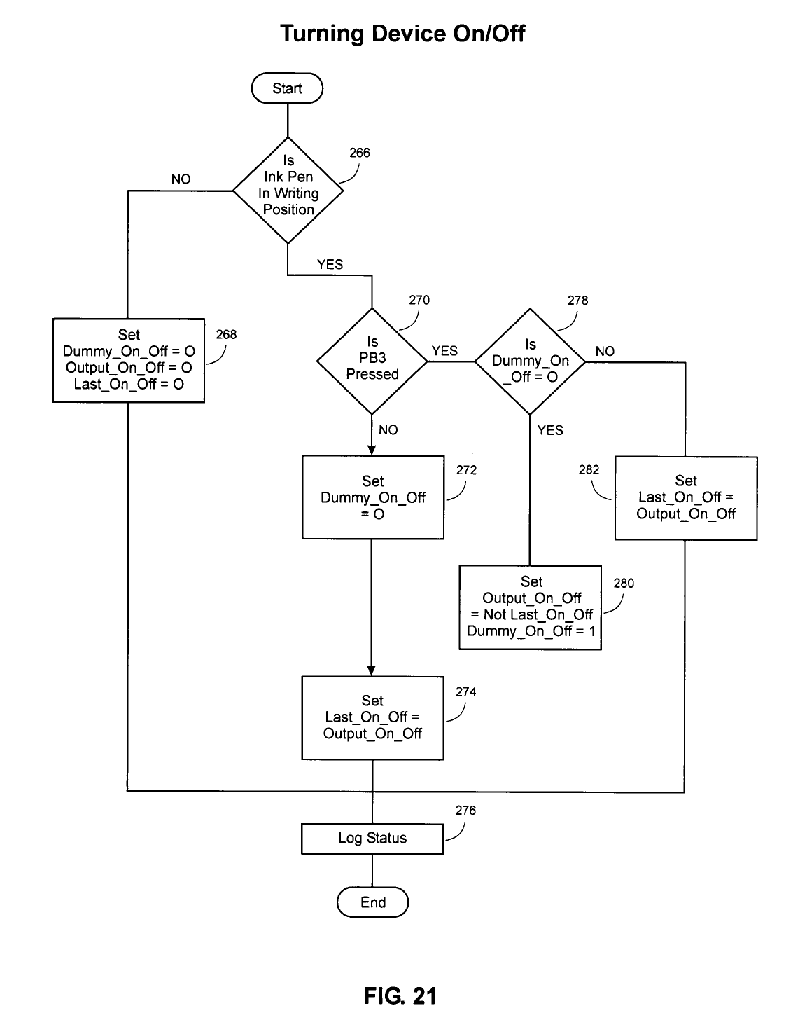

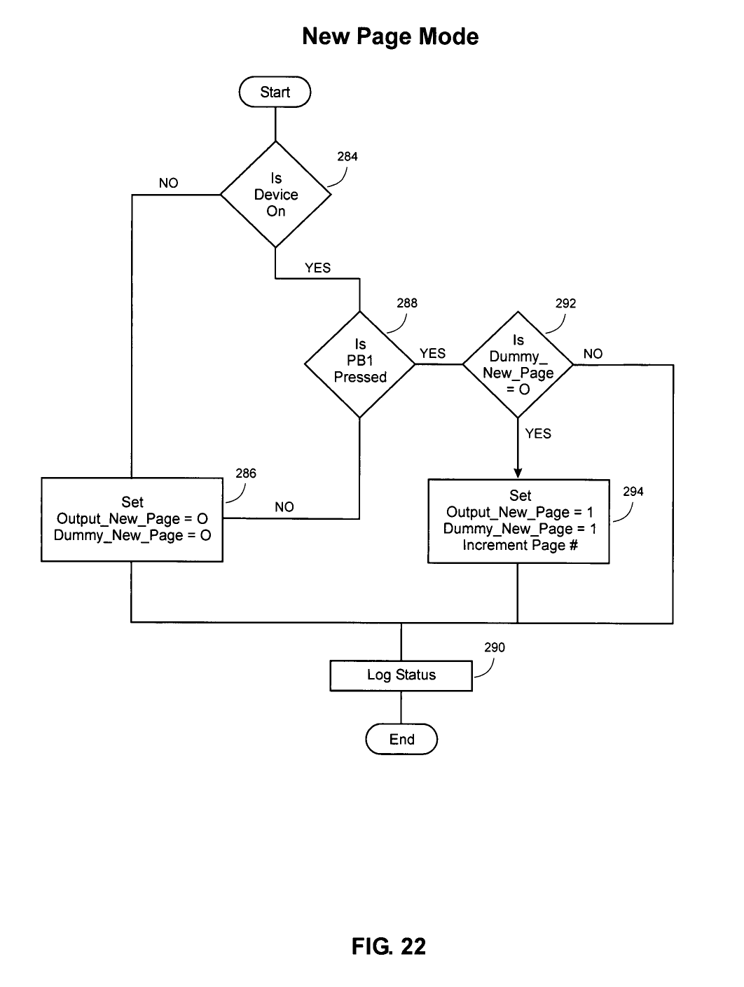

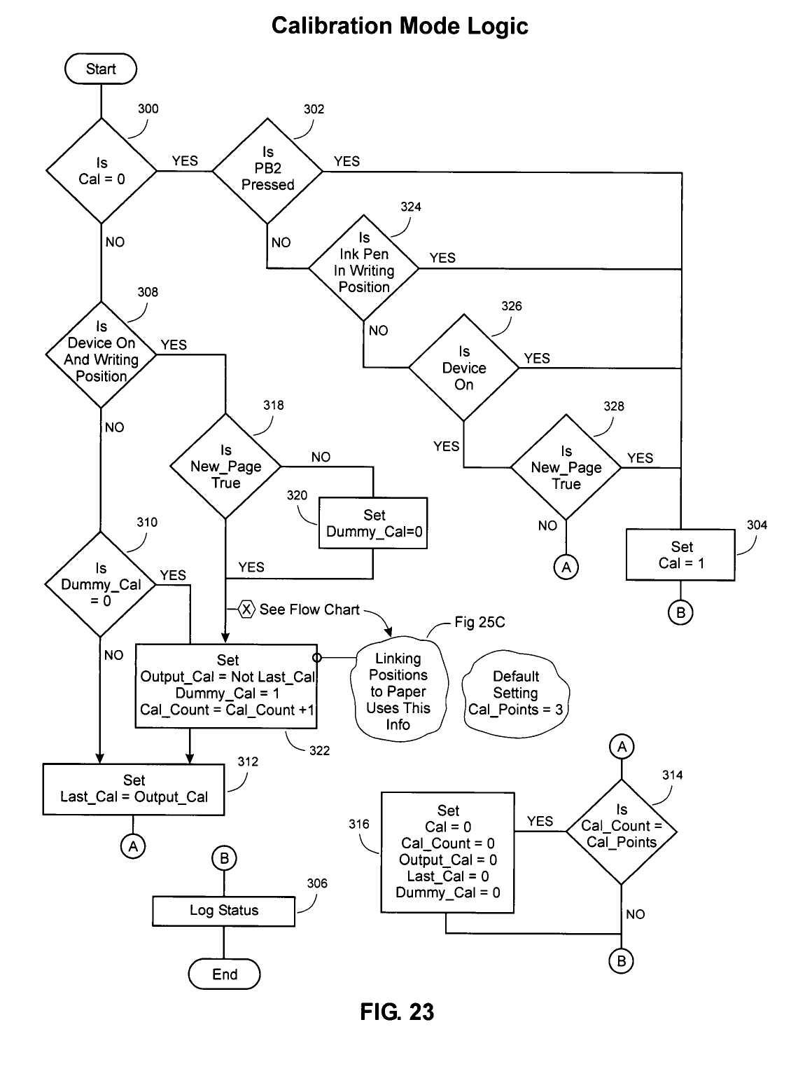

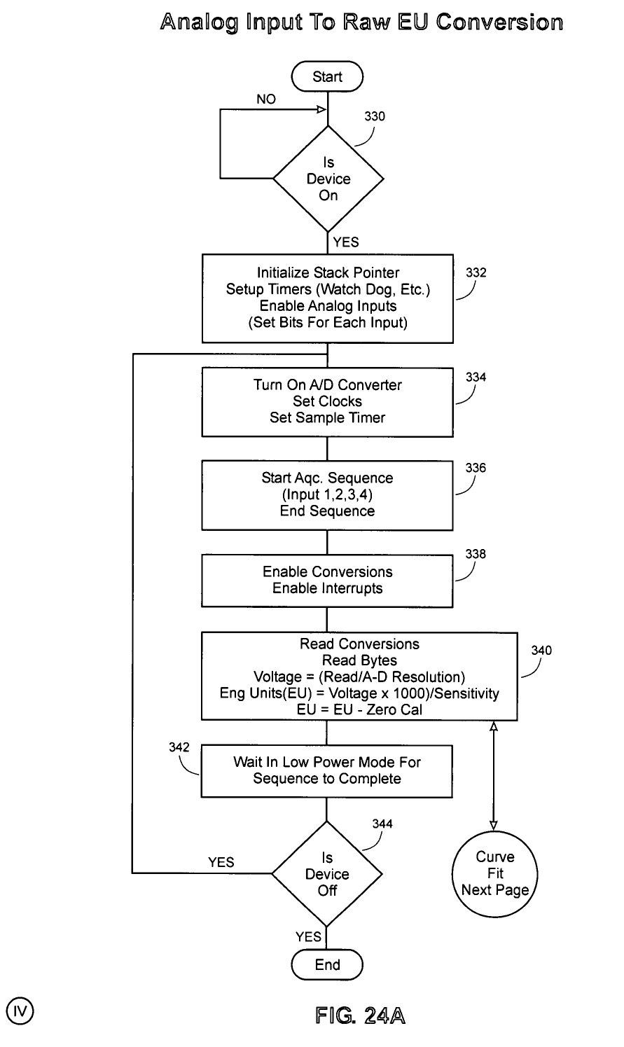

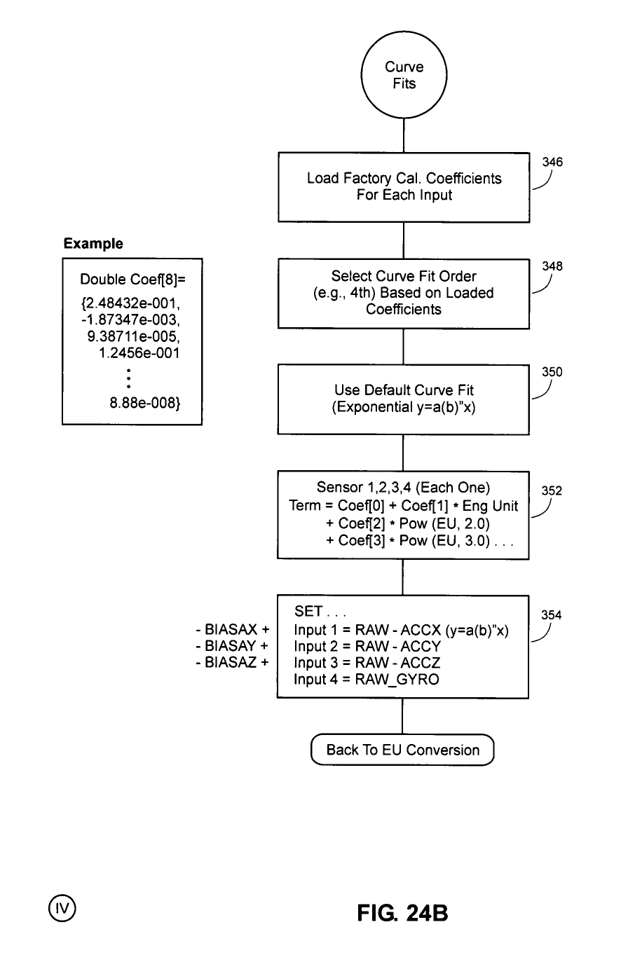

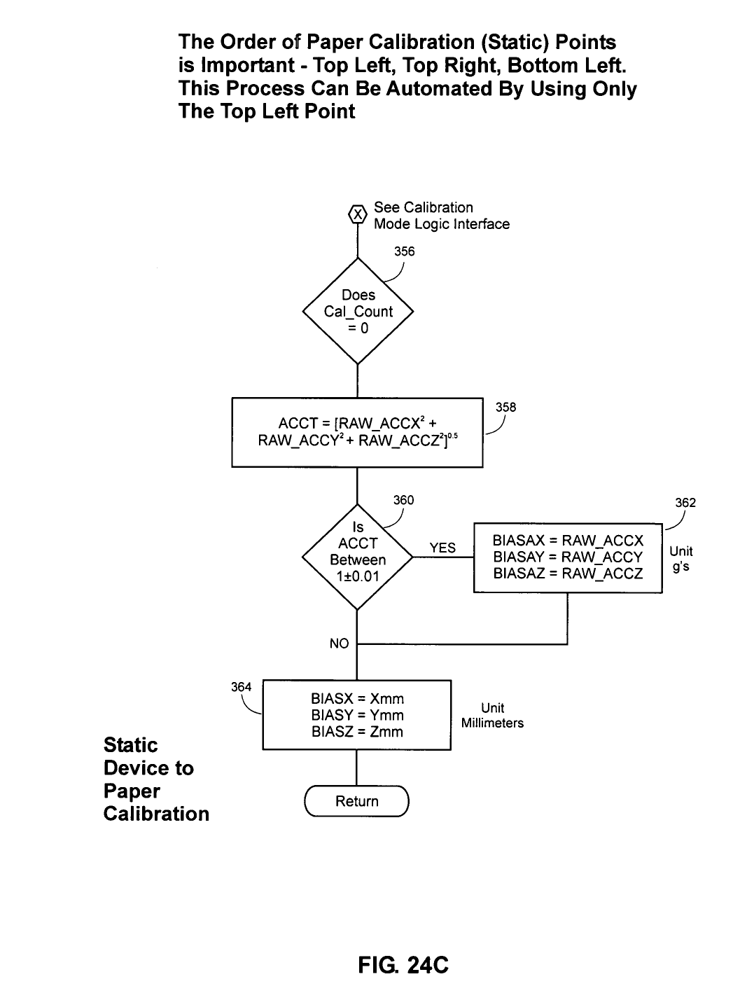

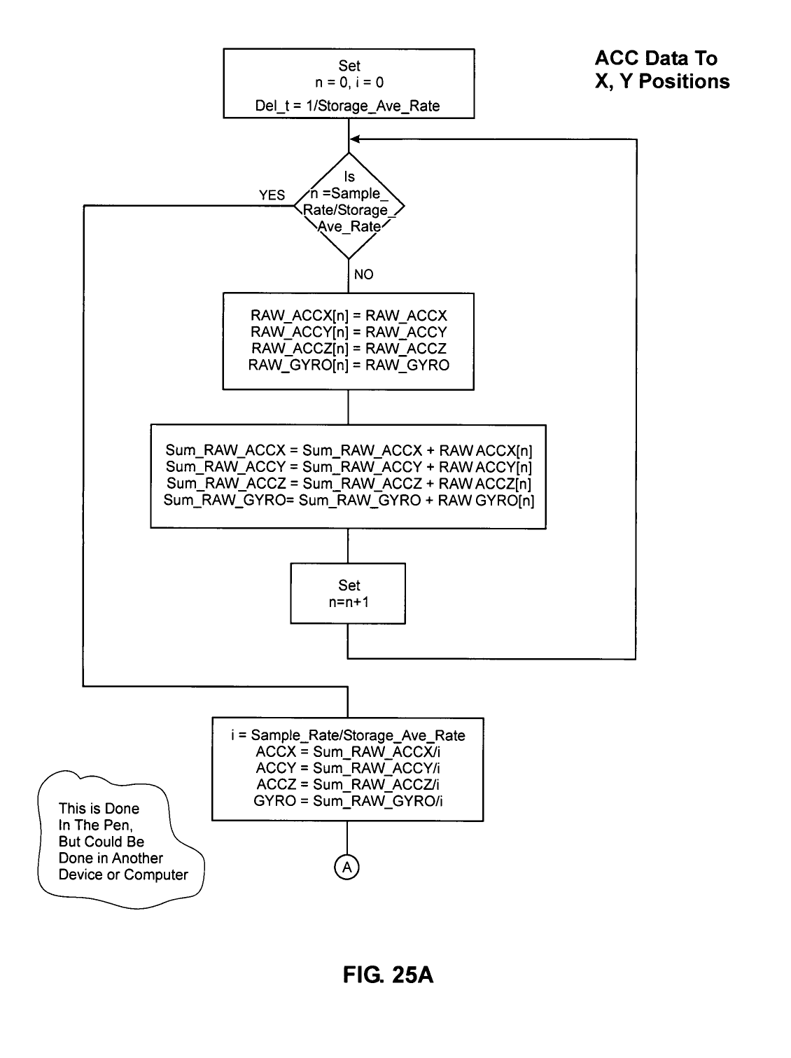

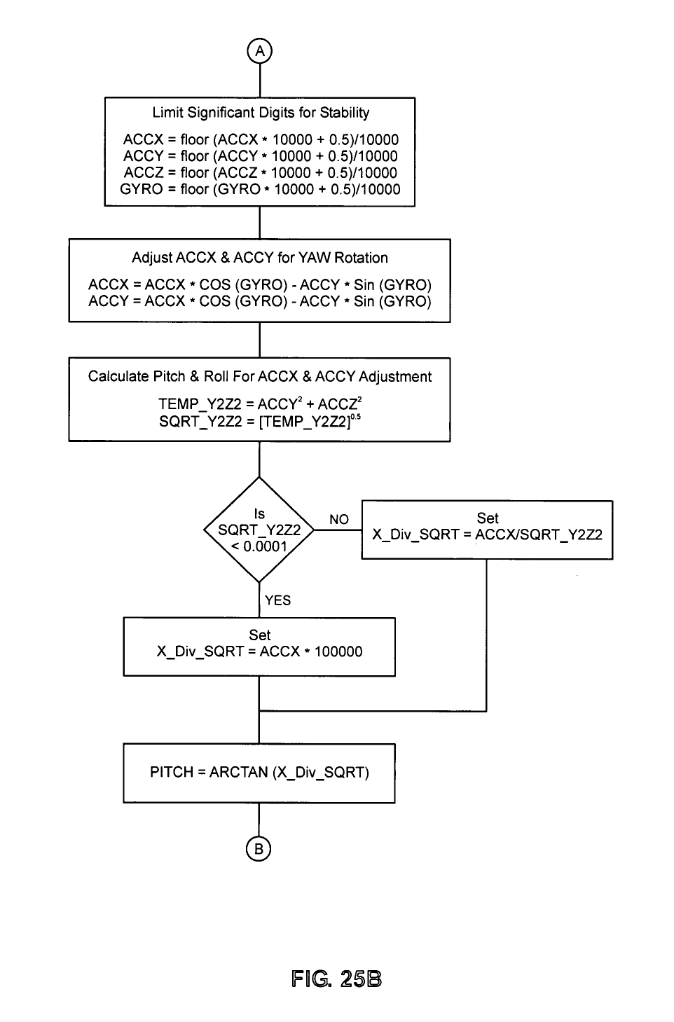

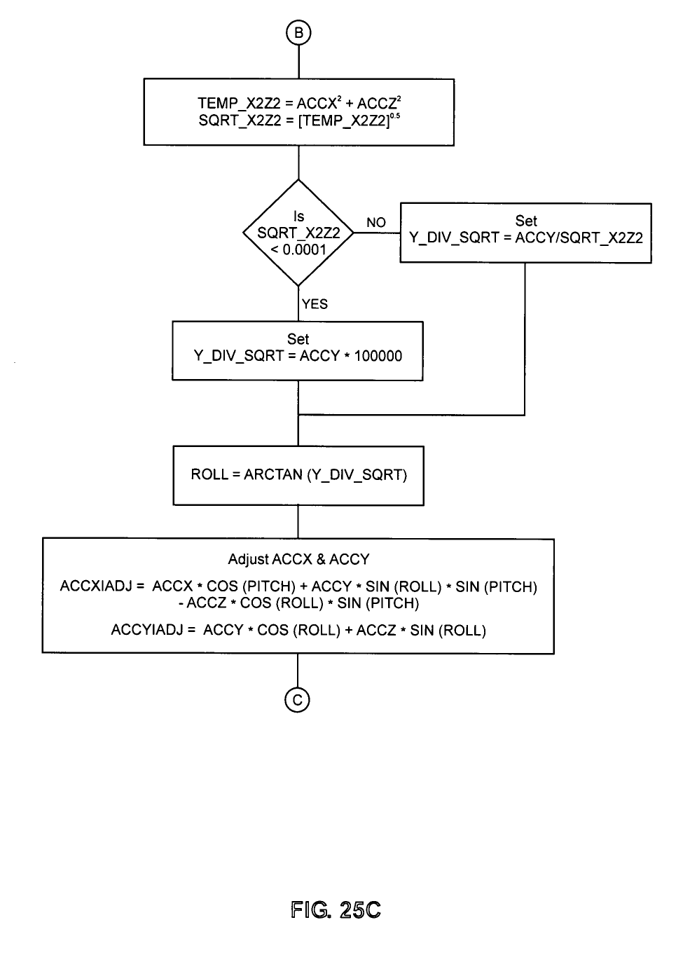

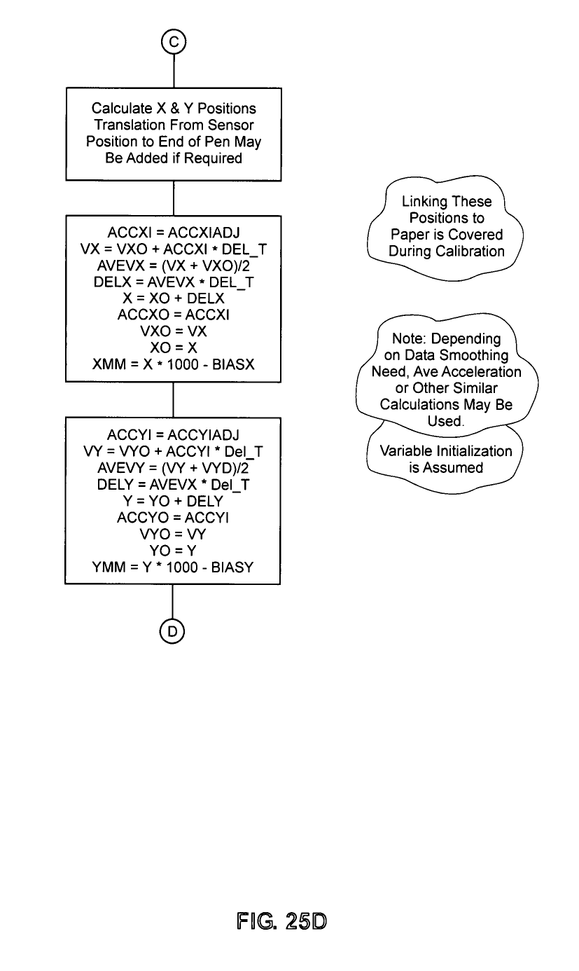

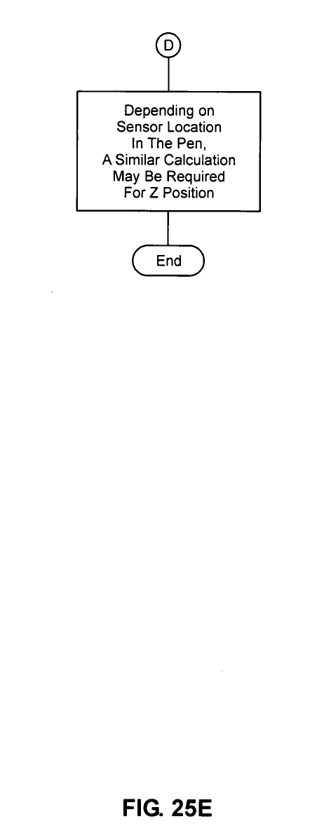

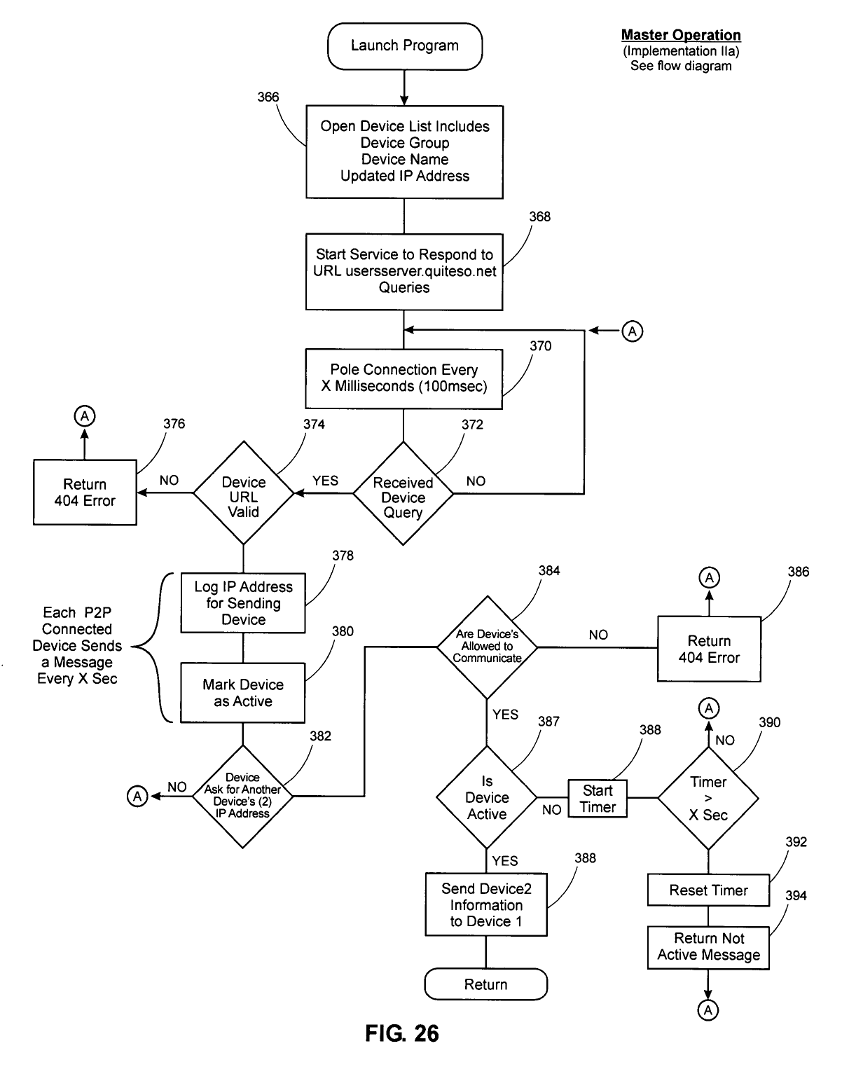

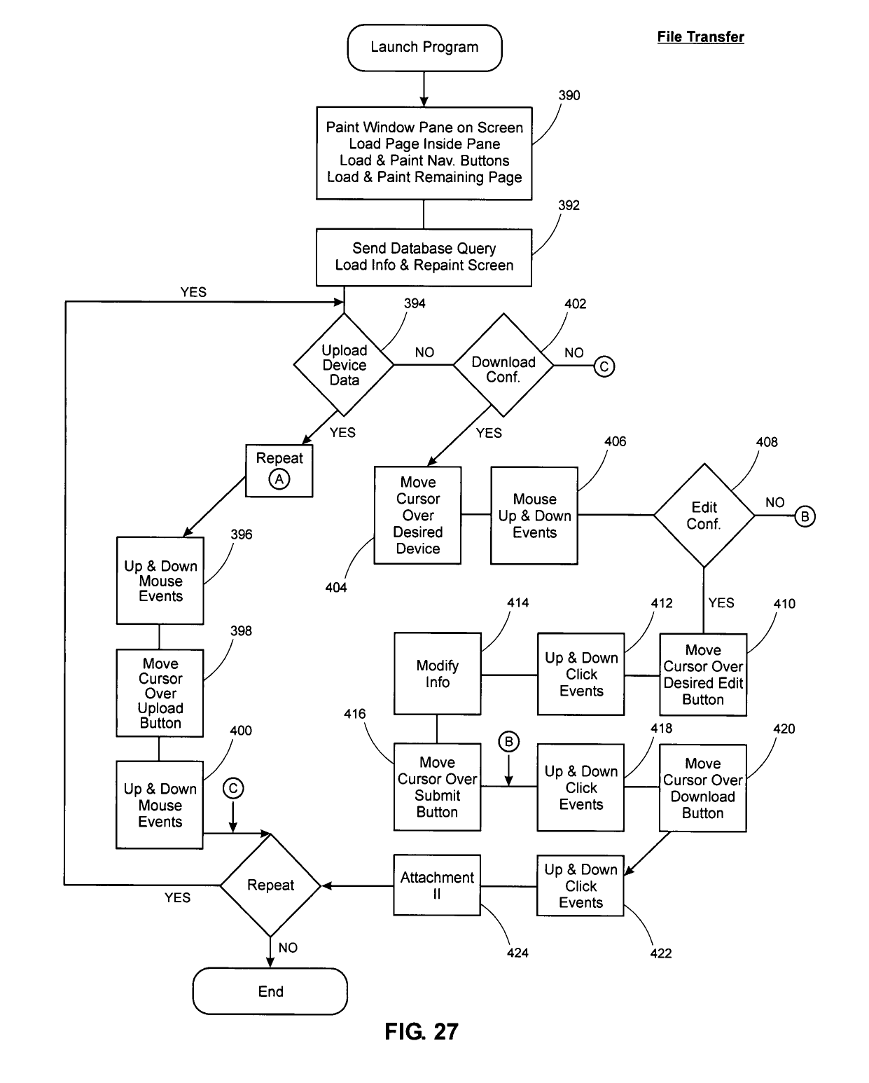

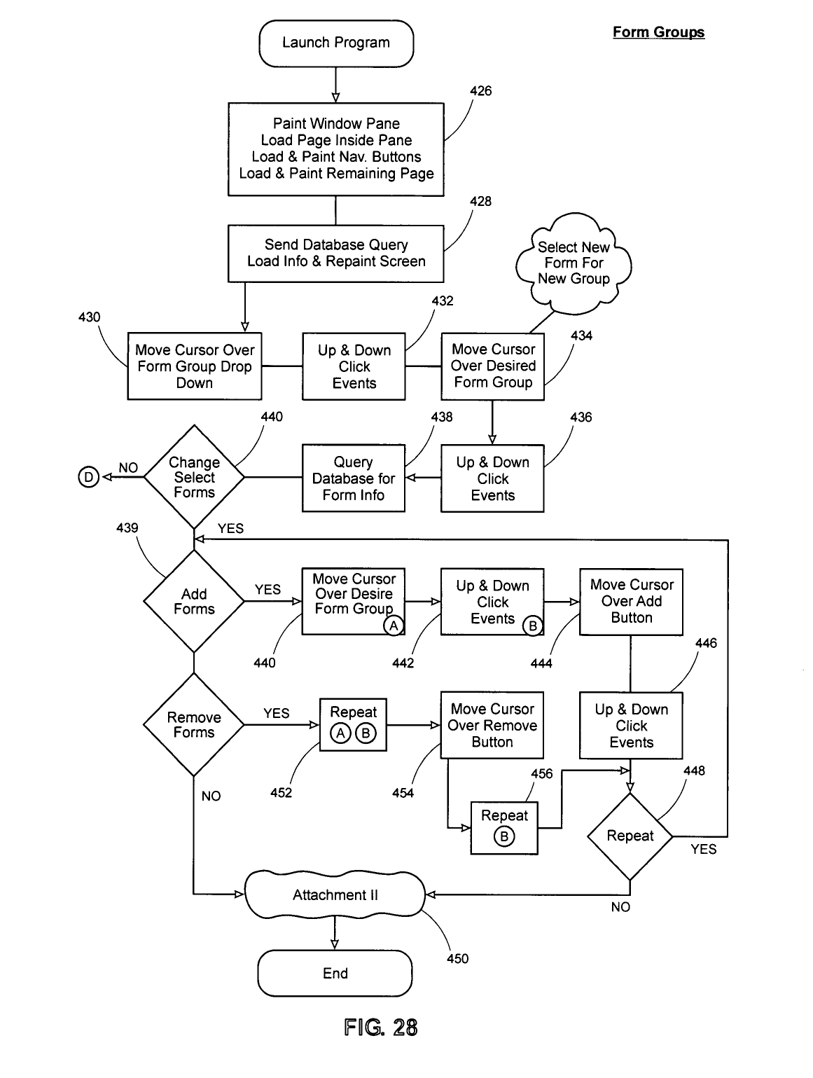

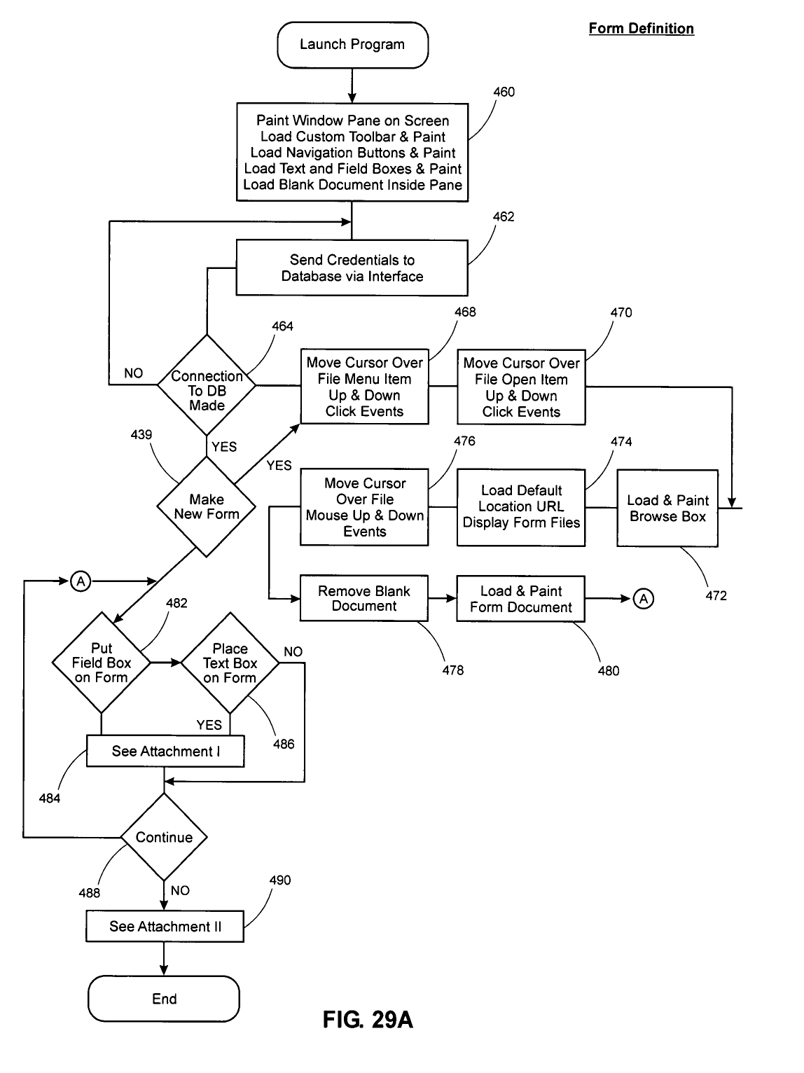

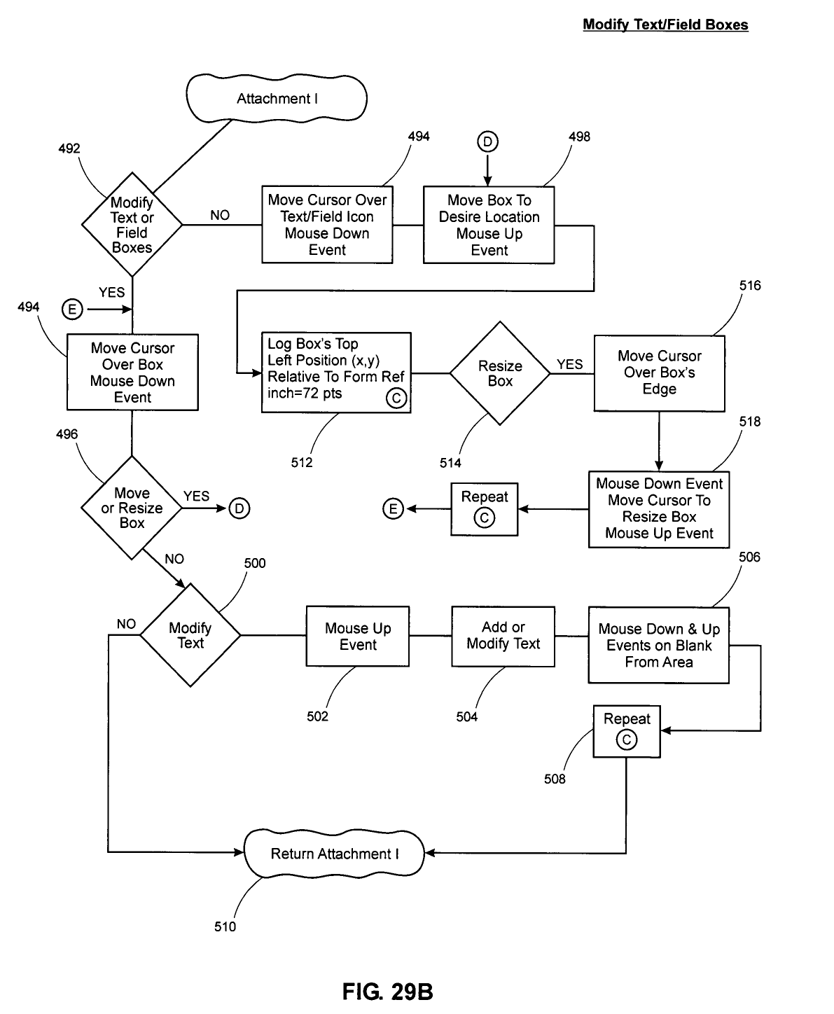

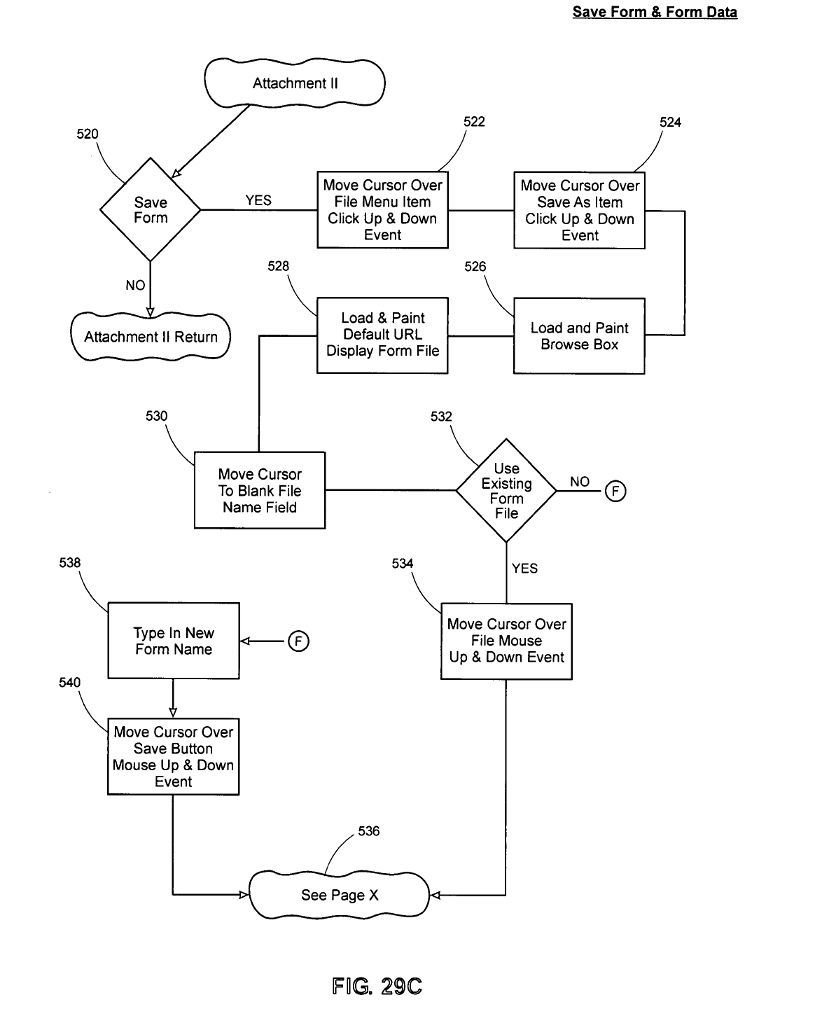

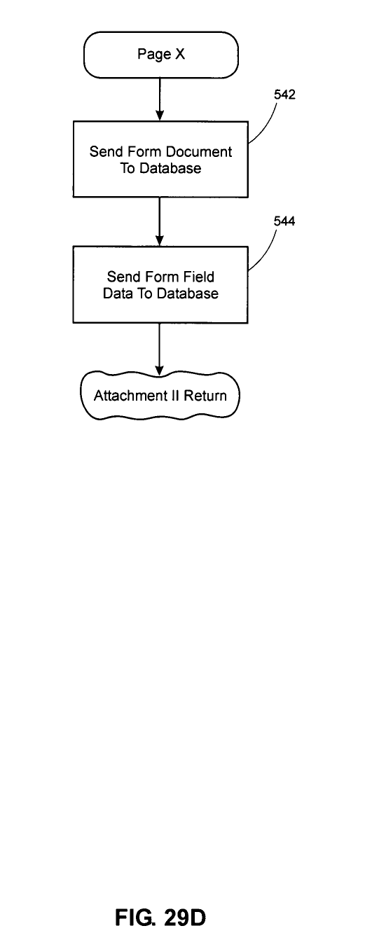

FIGS. 20A-29D illustrate exemplary flow charts for the computer system 104 and pen input device 102 in accordance with the present invention. In particular, FIGS. 20A-20B represent a software flow diagram for a pen input device configured for peer-to-peer operation. FIG. 21 is a software flow diagram for a pen input device 102 which illustrates the on/off operation. FIG. 22 is a software flow diagram for a pen input device 102 which illustrates the NEW_PAGE mode operation. FIG. 23 is a software flow diagram for a pen input device 102 which illustrates the calibration mode logic. FIGS. 24A-24C are software flow diagrams for a pen input device 102 which illustrates the conversion of the analog input data to digital data. FIGS. 25A-25E are software flow diagrams which illustrate the conversion of raw accelerometer data to X, Y position data. FIGS. 26A-29D illustrate a web application embodiment of the present invention. In particular, FIG. 26 is a software flow diagram of the basic web application. FIG. 27 is a software flow diagram of a file transfer function which forms part of the web application. FIG. 28 is a software flow diagram of a forms group function which forms part of the web application. FIGS. 29A-29B illustrate software flow diagrams for a forms definition web application.

### Pen Input Device Peer-to-Peer Operation

As mentioned above, FIGS. 20A and 20B represent a software flow diagram for a pen input device 102 configured for centralized peer-to-peer operation, as discussed above. The software for peer-to-peer operation, generally identified with the reference numeral 200, is resident on the pen input device 102. In step 202, the pen input device 102 opens connections to the computer system 104 (e.g., master) and various other pen input devices 102 either on an ad hoc basis or on the basis of a planned network. As illustrates, “device1” is the sending device and “device2” is the receiving device. If the receiving is connected, it initiates a polling loop in step 204 to establish communication with the sending device and the master. Once communication is established, the receiving device sends its credentials to the computer system 104 in the centralized peer-to-peer network. The systems checks in step 206 to determine if the master (i.e., computer system 204) responds. If not, a timer is initiated in step 208. The system then checks in system 210 to determine if the timer has timed out. If so, the timer is reset in step 212 and the user is notified in step 214. If the computer system 104 responds, the timer is reset in step 216. Next, in step 218, the system checks for error messages. If an error message has been generated, the user is notified in step 214 and the system proceeds to step 220 to determine if the user wants to continue. If not, the systems returns in step 222. If so, the system returns to step 204. If no error messages have been received, the system checks to determine if any commands and data have been exchanged with other pen input devices 102 in step 224. If not, the system checks in step 226 to determine whether the receiving pen input device is still connected in step 226. If so, the system returns to step 220 to determine if the user wants to continue and, if so, returns to step 204. Alternatively, if the user does not wish to continue, the system returns to step 222. If the receiving device is not connected, the system returns in step 228.

If command and data have been exchanged between the sending pen input device and the receiving device, as determined in step 224, the credentials for the receiving device are sent to the computer system (i.e., master) in step 230. Subsequently in step 232, the system will determine if the time for the master to respond has timed out. If so, the system will reset the time-out timer in step 212 and return to step 214. If the master responds within the time-out period as indicated in step 234, the system checks in system 236 to determine whether the receiving device is still connected. If not, the system proceeds to step 214 and notifies the user. If the receiving device is still connected, the master responds to the receiving pen input device by identifying the functions supported for the receiving device in step 238. In step 240, the receiving pen input device determines whether it has the necessary functions. If not, the system returns to step 214 and notifies the user. If so, the sending device sends its name and credentials to the receiving device in step 242. The system then checks in step 244 whether the time-out time for the master has expired prior to the master (i.e., computer system 104) responding. If so, the reset timer is reset in step 246. In step 248, the system checks for error messages. If there are none, the credentials of the receiving pen input device are received by the sending pen input device in step 250. If there are error messages, the system returns to step 214 and notifies the user. If the master fails to respond as indicated in step 252 the system returns to step 214 and notifies the user.

After the sending pen input device receives the credentials of the receiving pen input device, the system checks in step 254 to determine if the exchange was valid. If not, the system returns to step 214 and notifies the user. If so, the sending pen input device sends commands to the receiving pen input device in step 256. The receiving pen input device responds to those commands in step 258. If there has been no valid exchange of credentials as indicated in step 254, the system checks in step 260 to determine whether there are any pending commands. If not the system returns to step 262.

### Basic Pen Functionality

FIGS. 21 to 25E illustrate the basic pen functionality. Turning first to FIG. 21, the on/off functionality of a pen input device 102 is illustrated. Initially, in step 266, the system determines whether the pen is in a writing position. This is done by checking the inputs from the tri-axial accelerometers. If the system determines that the pen input device 102 is not in a writing position, various variables, such as DUMMY_ON_OFF; OUTPUT_ON_OFF and LAST_ON_OFF are set to zero in step 268. If the pen input device is determined to be in the proper writing position, the system determines in step 270 whether the on/off pushbutton (e.g., PB 3 has been depressed. If not, the system sets the variable DUMMY_ON_OFF equal to zero in step 272. In step 274, the variable LAST_ON_OFF is set equal to the variable OUTPUT_ON_OFF in step 274. The status is logged in 276.

If the system determines in step 270 that the on/off pushbutton PB3 has been depressed, the system checks in step 278 whether the variable DUMMY_ON_OFF is zero. The variable DUMMY_ON_OFF is zero, indicating that the on/off pushbutton PB3 has been depressed in step 278. If so, the system sets the variable OUTPUT_ON_OFF equal to the variable LAST_ON_OFF and DUMMY_ON_OFF equal to one. If the system determines in step 278 that the variable DUMMY_ON_OFF is not equal to zero, the variable LAST_ON_OFF is set equal to OUTPUT_ON_OFF in step 282.

The variables are defined as follows:
DUMMY_ON_OFF is an internal status flag used to process the logic.
OUTPUT_ON_OFF is a final variable indicating on off status of the pen
LAST_ON_OFF . . . internal variable indicating the previous state of the on/off bit. Use to toggle the OUTPUT_ON_OFF variable

FIG. 22 is a software flow diagram illustrating the NEW_PAGE mode functionality of the pen input device in accordance with the present invention. In step 284, the system determines whether the pen input device is on. If not, the system sets the variables OUTPUT_NEW_PAGE and DUMMY_NEW_PAGE equal to zero in step 286. If the system is on, the system checks in step 288 whether the NEW_PAGE mode pushbutton PB1 has been depressed. If not, the system returns to step 286 and logs the status in step 290. If the page mode pushbutton PB1 has been depressed, system checks in step 292 whether the variable DUMMY_NEW_PAGE is equal to zero. If not, the system returns to step 290. If so, the system sets the variables OUTPUT_NEW_PAGE and DUMMY NEW_PAGE equal to one and increments the page number in step 294.

The variables are defined as follows:
DUMMY_NEW_PAGE is an internal status flag used to process the logic.
OUTPUT_NEW_PAGE is a final variable indicating NEW_PAGE status of the pen input device
INCREMENT PAGE# is a variable indicating form page number

The calibration mode logic for the pen input device is illustrated in FIG. 23. Initially, the system checks in step 300 whether the variable cal equals zero. The purpose of this logic is to ensure that calibration mode is selected based on a change in mode (e.g., New_Page or after the user has taken the device away from the working space for a while). If so, the system checks in step 302 whether the calibration mode pushbutton PB2 has been depressed. If so, the system sets the variable cal equal to one in step 304. The system logs the statics in step 306.

Any time the variable CAL is set to zero, the system checks in step 308 whether the pen input device is in a writing position. If not, the system then checks to determine whether the variable DUMMY_CAL has been set to zero in step 310. If not, the variable LAST_CAL is set equal to the variable OUTPUT_CAL in step 312. The system then proceeds to step 314 to determine if the variable CAL_COUNT are equal. If not, the system proceeds to step 306 and logs the status. If so, the variables cal; count OUTPUT_CAL; LAST_CAL and DUMMY_CAL are set to zero in step 316.

If the system determines in step 308 that the variable cal is zero and the pen is in a writing position, the system checks in step 318 whether the end of the pen has been pressed by sensing the output of a pressure switch. If not, the system sets the variable DUMMY_CAL equal to zero in step 320. Any time the variable DUMMY_CAL is set to zero whether it be in response to the step 310 or 320, the system proceeds to step 322 and sets the variable OUTPUT_CAL equal to not LAST_CAL; sets the variable DUMMY_CAL equal to one and sets the variable CAL_COUNT equal to the variable CAL_COUNT+1.

If the system determines that the calibration mode logic pen has not been depressed in step 302, the system next proceeds to step 324 to determine if the pen is in a writing position. If so, the system proceeds to step 304 and sets the variable cal equal to one. If not, the system proceeds to step 326 to determine if the pen input device is on. If not, the system returns to step 304. If the pen input device is on and the pen input device is in a writing position, the system checks the variable NEW_PAGE to see if it has been set equal to one in step 328.

The variables are defined as follows:
CAL indicates if the device is in calibration mode.
PB2 is a calibration pushbutton
NEW_PAGE indicates if the current page is a NEW_PAGE
DUMMY_CAL is an internal status flag indicating if the device is still in calibration mode
OUTPUT_CAL indicates calibration status of the logic
DUMMY_CAL is an internal variable used to process the logic
CAL_COUNT indicates the current number of calibration points that he device is collecting
LAST_CAL indicates the previous state of the cal flag
CAL_POINTS is the total number of calibration points
ACCT is the root sum square of the overall acceleration value . . . a value of ˜1 means the device is not moving
biasax, biasax, baisaz . . . rezero difference between at rest value and recorded value
xmm,ymm,zmm engineering units in millimeters

FIGS. 24A, 24B and 24C represent a software flow diagram for converting analog input data to digital data. In step 330, the system checks whether the device is on. If not, the system loops and continues to check for turn-on of the device. Once the device is turned on, the system is initialized in step 332 by initializing the stack pointer as well as various set up timers including the watch dog timer and the system variables. Next in step 334, the system turns on the analog to digital converter, sets various clocks as well as the sample timer. In step 336, the system starts the conversion sequence for the various inputs. Each pen input device includes a tri-axial accelerometer as well as other devices as well as a pressure switch and a gyroscope which generate analog signals which need to be converted to digital signals. In step 336, the sequence of these various analog inputs is set while conversions and interrupts are enabled in step 338. Conversions are initiated in steps 340 in a conventional manner. The system may sit in a low-powered mode until the sequence is complete in step 342. At the end of each cycle, the system checks whether the pen input devices on or off in step 344. As long as the pen input device is on, the system loops back to step 336 and converts additional analog signals from the various sources discussed above.

FIG. 24B is an exemplary flow chart for an embodiment of the system in which the raw analog signals are first converted to digital signals and then filtered by a digital filter. The software flow diagram illustrated in FIG. 24B is used for curve fitting. Initially, the system loads the factory calibration coefficients for each input in step 346. After the calibration coefficients have been loaded, the curve fit order is selected based on the loaded coefficients in step 348. Alternatively, in step 350, a default curve fit may be used. For each of the analog input sources, the digital values are determined in step 352. In step 354 the accelerometer X, Y and Z inputs are set equal to the variables input one, input two, input three along with a negative bias. The analog value from the gyroscope is set equal to input four.

FIG. 24C illustrates a software flow diagram for calibrating the pen input device to a virtual writing surface. The order of static paper calibration points is important to be from top left to top right to bottom left. The process starts at the top left point. In step 356, the system checks the variable CAL_COUNT whether the variable CAL_COUNT has been set to zero. (John to provide the meaning of this). If so, the system calculates the accelerometer tolerance in step 358 by taking the square root of the sum of the square of the raw accelerometer output values raw_accx; raw_accy and raw_accz. If the accelerometer tolerance is between one plus or minus zero point one, the system sets the biases for the X, Y and Z accelerometers equal to the raw accelerometer values raw_accx; raw_accy and raw_accz. In step 362 if the tolerance of the accelerometers is not between the value, the bias for the triaxial accelerometers, bias X, bias Y and bias Z left to a predetermined millimeter value in step 364.

The variables are defined as follows:
Voltage is the analog voltage of the raw sensor signal (x acceleration)
A-d resolution is the number of bits of the analog to digital convert (12 bits)
sensitivity is the micro volts per count that the device provides
Zerocal is when the sensor is at reset the value of the reading . . .
coef[8] is the standard curve fit calibration constants provided by the factor for each sensor
y is an adjusted engineering unit value
n is an polynominal degree
term is the total calibration value
biasx,biasy,bias z . . . zero recal value
input1,input2, input3 are the above term values
raw_accx,raw_accy, raw_accz,raw_gyro are the compensated engineering unit values

FIGS. 25A-25E illustrate the flow chart for converting the raw accelerometer data from the triaxial accelerometers to X, Y, Z position data. These calculations are based upon the equation discussed above and thus are not described in detail. The variables are defined as follows:
del_t . . . time between data samples
storgage_ave_rate . . . rate at which the device stores position data
sample_rate . . . rate at which the device sample the analog values
raw_accx[n],raw_accy[n], raw_accz[n],raw_gyro[n] . . . raw value stored in an array
sum_raw_accx, sum_raw_accy, sum_raw_accz, sum_ram_gyro . . . summary of the raw_xxx[n] values
n,i . . . internal integer value
accx, accy,accz,gyro . . . average engineering unit values
floor( ) . . . round off value to significant values
cos, sin, arctan . . . standard trig functions
temp_y2z2 . . . sqrt_y2z2 . . . y_div_sqrt . . . internal calculation values
temp_x2x2 . . . sqrt_x2x2 . . . x_div_sqrt . . . internal calculation values
pitch . . . euler rotation angle
yaw . . . euler rotation angle
accxiadj . . . adjusted acceleration data based on euler angle compensation
accyiadj . . . adjusted acceleration data based on euler angle compensation
vx . . . x-axis velocity
vxo . . . initial x-axis velocity
avevx . . . ave value of velocity
delx . . . change in x position between last sample period
x . . . total x position
xo total initial x position
accxo . . . initial x acceleration date
xmm . . . final adjusted x position value
vy . . . y-axis velocity
vyo . . . initial y-axis veloc! ity
avevy . . . ave value of velocity
dely . . . change in y position between last sample period
y . . . total position
yo total initial y position
accyo . . . initial y acceleration date
ymm . . . final adjusted y position value

### Web Application

FIGS. 26 through 29D represent the flow charts for the web application identified above. As shown, the web application is related to a multi pen input device application configured in a centralized peer-to-peer configuration. Initially, in step 366, the master opens the device list which opens connections to all of the available devices currently identified in the “available devices” table illustrated in FIG. 12. In step 368, communication is established between the web host and the various pen input devices. In step 370, the web host periodically polled each of the available pen input devices. The system checks in step 372 whether the responses have been received from the available input devices. If not, the system loops back to step 370 and continues polling the available pen input devices. For every response received from a pen input device, the system checks in 374 whether the credentials responding pen input device are valid. If not, the system returns an error in step 376. If the receiving device credentials are valid, the IP address is logged in step 378 and the device is marked active in step 380. The system then checks for other devices in step 382. If there are no other devices, the system loops back to step 370. If other pen input devices respond, the system checks in step 384 whether these responding devices are configured to operate in a peer-to-peer mode. If not, the system proceeds to step 386 and returns to step 370. If on the other hand the responding pen input devices are configured for peer-to-peer operation, the system checks in step 386 whether the responding devices are active. If not, a timer is initiated in step 388. The system monitors the timer in step 390. If the timer times out, a timer is reset is step 392 and a message is returned in step 394 indicating that the device is not active. Once the timer has been reset the system returns to step 370 and continues polling pen input devices in the peer-to-peer network. If the responding device is determined to be active, the responding device information is sent to a sending device in step 388.

The file transfer function is illustrated in FIG. 27. As indicated in step 390, the window pane is painted on the screen, for example, as illustrated in FIG. 12. The system then sends an inquiry to the data base in step 392 to load the information in the various information boxes illustrated in FIG. 12. The system checks in step 394 whether the upload device data option has been selected. This option is selected by moving the mouse cursor over the upload device upload button as illustrated in FIG. 12 in steps 396 and 398 and depressing the mouse button step 400. Alternatively, in step 402, the download configuration button can be selected. In order to select the download configuration button, the cursor is moved over the download configuration button in step 404 and the download button is selected in step 406. In order to edit a configuration, the mouse cursor is moved over the desired edit button in step 410. As shown in FIG. 12, various system edits can be made, for example, device groups; form group and IP address. In order to select an edit button, the mouse button is depressed in step 412 over that edit button and the information is modified in step 414. After the desired information is edited, the submit button is selected by moving the cursor over the submit button at 416 and clicking on the button in step 418. After the submit has been depressed, the download button is selected in steps 420 and 422. The system then proceeds to the safe form and data function 424. (FIG. 29C).

The software flow diagram for the form groups webpage in FIG. 13 is shown in FIG. 28. Initially, in step 426, the window pane is painted as illustrated in FIG. 13. Subsequently, in step 428, the data base inquiry is made to fill in the data in the various information boxes in the form groups webpage illustrated in FIG. 13. The form groups webpage is used to form peer-to-peer groups among pen input devices. In order to form a group, the cursor is moved over a drop-down menu in step 430. The desired form group may be selected by way of a mouse in steps 432, 434 and 436. After the form group has been selected, the data base is queried for the form inflow in step 438. The system also allows the forms to be added and deleted from a form group. For example, with reference to FIG. 13, the text box identified as available forms indicates forms available to the system. The text box identified as selected forms relates to forms that had been selected for a particular group. Forms may be added or deleted from the group (i.e., selected forms text box). In particular, in order to add forms as indicated in step 439, the cursor is used to highlight the desired form in the available form text box by moving the cursor over the desired form in step 440 and clicking on that form in step 442. In order to add the form to the selected forms text box the cursor is moved over the add pushbutton in step 444 and selected in step 446. The system then checks in step 448 whether any additional forms are to be added to the selected forms form group. If not, the system proceeds to step 450 to save the forms. On the other hand, if forms are to be removed, the desired form is highlighted in the selected forms text box by moving the cursor over the form and clicking on the mouse button in step 452. In order to remove the form from the selected forms text box, the cursor is moved over the remove button and selected in steps 454 and 456.

FIGS. 29A-29D illustrate flow charts for creating a form, for example, as illustrated in FIG. 17, the form definition window is selected from another web page by selecting the defined form button. Once the defined form button is selected, a window is painted in step 460. The system then sends the credential of the web host to the data base by way of an interface in step 462. In step 464 the system checks whether the connection to the data base has been made. If so, a user can create a new form. In order to create a new form, the file menu item is selected in step 468. Once the file open function is selected in step 470, the data base will load and paint a box, in steps 472-480. In step 482, the system determines whether another field box is to be added to the form. If so, the system proceeds to step 484 and determines whether modifications or editing of the text in that field box are required. If the various field boxes have been added to the form, the system allows for the text to be overlaid in those boxes in step 486. After all of the forms have been set up with the text overlay in the various text boxes as indicated by step 488, the system is saved in step 490.

FIG. 29B is a software flow diagram for modifying the text boxes. If a text box is to be modified, the cursor is simply moved over the text box and selected in step 494. The system also allows text boxes to be modified or resized 496. If modification or resizing is selected, the system proceeds to step 498. In step 498 the text box is moved simply by moving the cursor within the box and dragging the box to the desired location on the form. If the text within the text box is to be modified as indicated in step 500, the cursor is simply moved to the appropriate text box in step 502. Text is added or removed in step 504, added text is highlighted in step 506 and selected with the mouse button. The system then returns to steps 508 and 510 to see if additional modifications are required.

Any time a field box is moved, the box's top left X Y position relative to the form is logged in step 512. The system also allows for boxes to be resized in step 514 by simply moving the cursor over an edge of the box in step 516 and dragging the edge in step 518 to increase or decrease the size of the box.

FIG. 29C illustrates the flow diagram for saving the form and form data. Any time forms have been created, the user has the option of saving the form in step 520. In order to save the form, the cursor is moved to file menu in step 522 and the save as and selects the “save as function” in step 524. After the save as function has been selected, the system loads and paints a browse box in step 526 and displays the form in step 528. In order to name the fields in the field boxes, the cursor is moved to the file name field in step 530. In step 532, the system checks whether the system form file is requested. If not, the cursor over the file button in step 534 and the form is sent to the data base in step 536. If it is desired to rename the form, the new form name is typed in step 538 and saved in step 540.

FIG. 29D illustrates the flow diagram for saving forms created in a web application. The form document is sent to the data base 120. The field data is also sent to the data base in step 544.

Obviously, many modifications and variations of the present invention are possible in light of the above teachings. Thus, it is to be understood that, within the scope of the appended claims, the invention may be practiced otherwise than is specifically described above.

What is claimed and desired to be secured by a Letters Patent of the United States is:

1. A computer system comprising:
one or more pen input devices; and
one or more computers, at least one of said one or more computers configured as a master forming a master-slave configuration with said one or more pen-input devices, wherein said at least one computer, configured as a master, is in communication with a database for storing data for one or more forms, said forms being selectable by said one or more pen input devices and wherein said pen input devices are configured to enable data to be filled in on a selected form defining form data by way of movements of said one or more pen-input devices and transmitting said data to said master for storage on said database.

2. A computer system as recited in claim 1, wherein said one or more pen input devices are configured to selectively and electronically erase said form data.

3. The computer system as recited in claim 1, wherein said computer system is configured with at least two pen input devices and wherein said pen input devices are configured to enable peer-to-peer wireless communication between said pen-input devices.

4. The computer system as recited in claim 1, wherein said one or more pen input devices are configured to automatically store form data when said master computer is unavailable.

5. The computer system as recited in claim 4, wherein said one or more pen-input devices are configured to automatically transfer data to said master when said master becomes available.

6. The computer system as recited in claim 1, wherein said pen-input system is configured to write on a virtual writing surface.

7. The computer system as recited in claim 1, wherein said database includes at least two forms, said forms being selectable by said one or more pen-input devices.

8. The computer system as recited in claim 1, wherein said forms are stored in said data base by one or more attributes.

9. The computer system as recited in claim 8, wherein one of each form is stored by a form name.

10. The computer system as recited in claim 1, wherein said pen-input device includes a calibration mode which enables the pen-input device to be linked to a virtual writing surface.

11. The computer system as recited in claim 1, wherein said pen-input device is configured as an electronic stylus.

12. The computer system as recited in claim 1, wherein said pen-input device is configured as an inertial device.

13. A pen-input device comprising:
a microprocessor;
a plurality of inertial components for detecting the inertial position of said pen-input device on a virtual surface defining pen-input data;
a user interface for receiving user inputs;
a memory for storing said inertial position data and said user inputs under the control of said microprocessor;
a communications module for enabling said pen-input device to communicate with remote devices under the control of said microprocessor;

14. The pen-input device as recited in claim 13, wherein said pen-input device is configured to enable virtual erasing of said pen-input data.

15. The pen-input device as recited in claim 13, wherein said pen-input device is configured with at least three modes of operation; an on/off mode, a calibration mode, and a write mode.

16. The pen-input device as recited in claim 15, wherein at least three modes of operation are selectable by way of said user interface.

17. The pen-input device as recited in claim 16, wherein said user interface includes at least one push button.

18. The pen-input device as recited in claim 13, wherein said pen-input device also includes an ink cartridge.

19. The pen-input device as recited in claim 13, wherein said pen-input device is configured to automatically transfer pen-input data to a remote device.

20. The pen-input device as recited in claim 13, wherein aid pen-input device is configured to enable form data stored in a remote location to be selectably uploaded.

21. The pen-input device as recited in claim 20, wherein said pen-input device is configured to enable data input into a plurality of selectable forms.

22. The pen-input device as recited in claim 21, wherein said pen-input device is configured to communicate with another pen-input device forming a peer-to-peer network.

23. The pen-input device as recited in claim 22, wherein said pen-input device is configured to communicate with a remote host computer.

24. The pen-input device as recited in claim 15, wherein said pen-input device is configured so that its operating configuration can be configured by a remote device.

25. The pen-input device as recited in claim 15, wherein said pen-input device is configured to select one or more forms from a remote source for the purpose of providing form data.
